(19) United States
(12) Patent Application Publication
(10) Pub. No.: US 2025/0284231 A1
(43) Pub. Date: Sep. 11, 2025

(54) IMAGE FORMATION DEVICE

(71) Applicant: BROTHER KOGYO KABUSHIKI KAISHA, Nagoya (JP)

(72) Inventor: Tatsuya KOYAMA, Nagoya (JP)

(73) Assignee: BROTHER KOGYO KABUSHIKI KAISHA, Nagoya (JP)

(21) Appl. No.: 19/219,603

(22) Filed: May 27, 2025

Related U.S. Application Data
(63) Continuation of application No. PCT/JP2023/039998, filed on Nov. 7, 2023.

(30) Foreign Application Priority Data
Nov. 28, 2022 (JP) 2022-189535
Nov. 28, 2022 (JP) 2022-189536
Nov. 28, 2022 (JP) 2022-189537

(51) Int. Cl. G03G 15/20; G03G 15/00

(52) U.S. Cl. CPC G03G 15/2039; G03G 15/2064; G03G 15/6511; G03G 15/6564; G03G 15/6573; G03G 15/6582; G03G 2215/00413; G03G 2215/00426; G03G 2215/00814

(57) ABSTRACT

An image forming device includes an image forming unit configured to form an image on a sheet, a fixing unit configured to fix the image on the sheet, the fixing unit including heating rotation body, a heater configured to heat the heating rotation body, and a pressure rotation body configured to form a nip portion between the heating rotation body and the pressure rotation body, a discharge roller disposed downstream of the fixing unit in a conveying direction of the sheet, and configured to discharge the sheet, a main motor configured to transmit a drive force to at least one of the heating rotation body or the pressure rotation body, a cutter disposed downstream of the fixing unit in the conveying direction, and configured to cut the sheet, and a controller.

### REFERENCE TO RELATED APPLICATIONS

This is a continuation application of International Application No. PCT/JP2023/039998 filed on Nov. 7, 2023, which claims priority from Japanese Patent Application No. P2022-189535 filed on Nov. 28, 2022, Japanese Patent Application No. P2022-189536 filed on Nov. 28, 2022, and Japanese Patent Application No. P2022-189537 filed on Nov. 28, 2022. The entire contents of the aforementioned applications are incorporated herein by reference.

### BACKGROUND ART

In the image forming device disclosed in a related art, a sheet having passed through a fixing unit is discharged from a discharge unit provided above the fixing unit. A cutter provided between the fixing unit and the discharge unit cuts the sheet in a direction orthogonal to a conveying direction. Further, a leading end portion of the sheet discharged from the fixing unit is detected by a discharge switch, and a discharge roller for discharging the sheet stops after a predetermined time has elapsed. When the discharge roller stops, a boundary line between a leading image on the sheet and a second image is located at a cutting position of the cutter, and the cutter is driven to cut the sheet along the boundary line.

### SUMMARY

An image forming device includes an image forming unit configured to form an image on a sheet, a fixing unit configured to fix the image on the sheet, the fixing unit including a heating rotation body a heater configured to heat the heating rotation body and a pressure rotation body configured to form a nip portion between the heating rotation body and the pressure rotation body, a discharge roller disposed downstream of the fixing unit in a conveying direction of the sheet, and configured to discharge the sheet, a main motor configured to transmit a drive force to at least one of the heating rotation body or the pressure rotation body, a cutter disposed downstream of the fixing unit in the conveying direction, and configured to cut the sheet, and a controller. The controller is configured to control the heater such that a temperature of the fixing unit becomes a first temperature for fixing the image on the sheet, control the main motor to rotate the heating rotation body or the pressure rotation body to convey the sheet, stop the discharge roller in a case where a cutting position on the sheet reaches a disposing position of the cutter, and then control the cutter to cut the sheet with the cutter, and at a time point when cutting of the sheet with the cutter starts set a target value of the temperature of the fixing unit to a second temperature lower than the first temperature to control the heater, or control the main motor to drive the main motor to rotate the heating rotation body or the pressure rotation body.

### BRIEF DESCRIPTION OF DRAWINGS

FIG. 1 is a diagram showing an example of a schematic configuration of an image forming device.

FIG. 2 is a block diagram showing an electrical configuration of the image forming device shown in FIG. 1.

FIG. 3 is a main flowchart showing an example of a flow of a print control performed by a CPU of the image forming device shown in FIG. 1.

FIG. 4 is a sub flowchart showing an example of a flow of a printing-cutting process in FIG. 3.

FIG. 5 is a timing chart showing an example of a relation between a drive timing of each drive unit and a temperature of a fixing device.

FIG. 6 is a diagram for explaining cutting of a sheet passing through a nip portion.

FIG. 7 is a timing chart showing an example of the relation between the drive timing of each drive unit and the temperature of the fixing device.

FIG. 8 is a sub flowchart showing an example of the flow of the printing-cutting process in an image forming device.

FIG. 9 is a timing chart showing an example of the relation between the drive timing of each drive unit and the temperature of the fixing device in the image forming device.

FIG. 10 is a sub flowchart showing an example of the flow of the printing-cutting process in an image forming device.

FIG. 11 is a timing chart showing an example of a relation between the drive timing of each drive unit and a temperature of a fixing device.

FIG. 12 is a diagram for explaining the cutting of the sheet passing through the nip portion.

FIG. 13 is a diagram for explaining cutting of a sheet by a cutter.

FIG. 14 is a timing chart showing an example of the relation between the drive timing of each drive unit and the temperature of the fixing device in Modification 1 of the image forming device.

FIG. 15 is a sub flowchart showing an example of the flow of the printing-cutting process in an image forming device.

FIG. 16 is a timing chart showing an example of the relation between the drive timing of each drive unit and the temperature of the fixing device.

FIG. 17 is a diagram for explaining a relation between the sheet passing through the nip portion and driving of a heater.

### DESCRIPTION

### Embodiment 1

### [Overall Configuration of Image Forming Device 1]

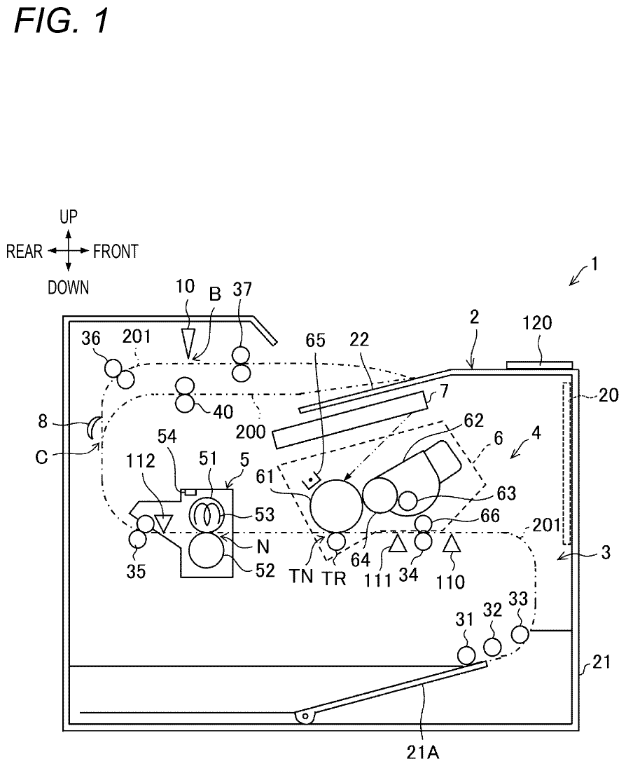

A schematic configuration of an image forming device 1 will be described with reference to FIG. 1. FIG. 1 is a diagram showing an example of the schematic configuration of the image forming device 1 according to Embodiment 1. As shown in FIG. 1, the image forming device 1 is a monochrome laser printer, and includes a device main body 2, a conveying unit 3, an image forming unit 4, a fixing device 5, a cutter 10, and an operation panel 120. Hereinafter, for convenience of description, an up-down direction and a front-rear direction of the image forming device 1 are defined as indicated by arrows in FIG. 1.

The device main body 2 includes a front cover 20, a feed tray 21, a discharge tray 22, a conveying path 201, and a branch path 200. The device main body 2 has, on a front surface thereof, the front cover 20 configured to be opened and closed.

The device main body 2 has, at a lower portion thereof, the feed tray 21 that is removable. A sheet P is placed on the feed tray 21. The sheet P is a standard sheet such as an A4 size sheet. The sheet P is, for example, a paper medium such as plain paper and thick paper. The device main body 2 includes the discharge tray 22 at an upper portion thereof. The sheet P on which an image is formed is placed on the discharge tray 22.

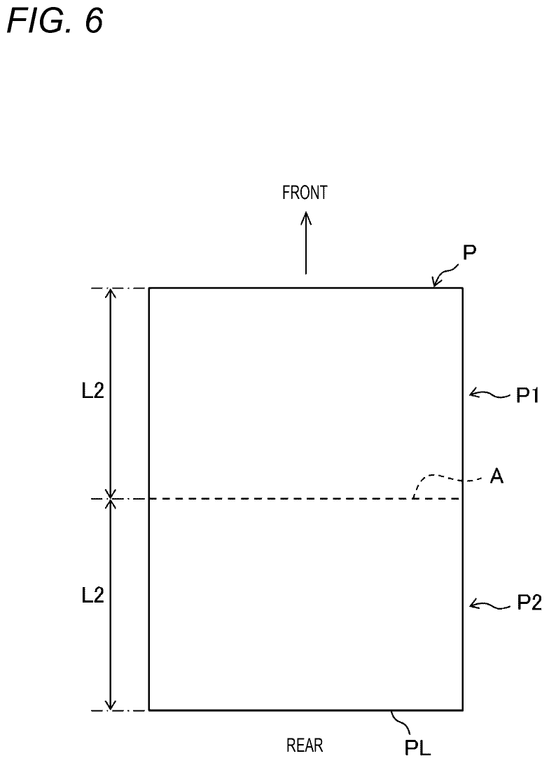

The conveying path 201 is a path used for conveying the sheet P placed on the feed tray 21 to the cutter 10 via the image forming unit 4 and for conveying a first sheet P1 and a second sheet P2 (see FIG. 6) cut by the cutter 10 toward the discharge tray 22. The branch path 200 is a path used for conveying the sheet P, which is not cut by the cutter 10, toward the discharge tray 22, separately from the conveying path 201.

A conveyance start point of the sheet P in the branch path 200 refers to a merging position C with the conveying path 201. The merging position C is provided upstream of a first discharge roller 36 and a third discharge roller 40 and downstream of the fixing device 5 in a conveying direction of the sheet P. The conveying direction of the sheet P is a direction from the feed tray 21 toward the discharge tray 22 along the conveying path 201, or is a direction from the feed tray 21 toward the discharge tray 22 along the conveying path 201 and the branch path 200. Hereinafter, the conveying direction of the sheet P is simply referred to as the conveying direction.

The branch path 200 is disposed below the conveying path 201. In the vicinity of the merging position C, a flapper 8 used for distributing the sheet P to the conveying path 201 or the branch path 200 is provided. In a case where the flapper 8 is located at a first position, the flapper 8 distributes the sheet P to the branch path 200. Further, in a case where the flapper 8 is located at a second position, the flapper 8 distributes the sheet P to the conveying path 201. The flapper 8 operates by a drive force from a drive motor (not shown).

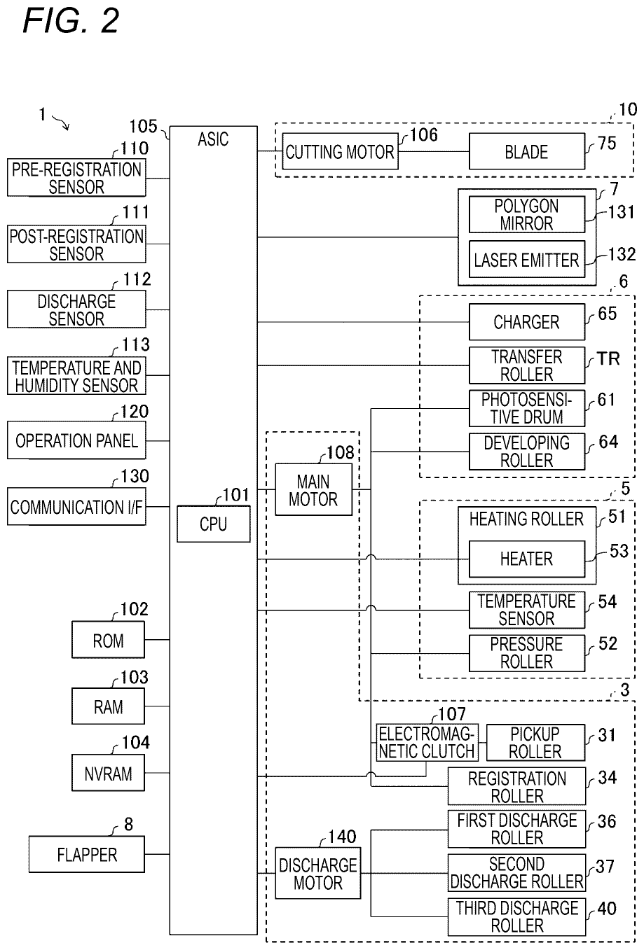

The conveying unit 3 includes a pickup roller 31, a separation roller 32, a paper dust removing roller 33, a registration roller 34, a roller 35, the first discharge roller 36, a second discharge roller 37, and the third discharge roller 40. Further, the conveying unit 3 includes an electromagnetic clutch 107, a main motor 108, and a discharge motor 140 (see FIG. 2).

When a drive force is transmitted from the main motor 108, the pickup roller 31 picks up the sheet P pushed upward by a sheet pressing plate 21A in the feed tray 21. Then, the pickup roller 31 is configured to convey the sheet P to the image forming unit 4 by conveying the sheet P toward the conveying path 201. The separation roller 32 is configured to separate the sheet P picked up by the pickup roller 31 one by one. The paper dust removing roller 33 is configured to remove paper dust and the like on a surface of the sheet P.

The registration roller 34 is a conveying roller closest to a photosensitive drum 61 to be described later among a plurality of conveying rollers configured to convey the sheet P, and is disposed upstream of the photosensitive drum 61 to be described later of the image forming unit 4 in the conveying path 201. The registration roller 34 is disposed upstream of the image forming unit 4 in the conveying path 201 and is a conveying roller closest to the photosensitive drum 61. The plurality of conveying rollers refer to, for example, the pickup roller 31, the separation roller 32, and the paper dust removing roller 33. The registration roller 34 is configured to align a direction of a leading end of the sheet P and then convey the sheet P toward the image forming unit 4. The roller 35 is configured to convey the sheet P having passed through the fixing device 5 toward a first discharge roller 36 side.

The first discharge roller 36 and the second discharge roller 37 are disposed downstream of the merging position C in the conveying path 201. The first discharge roller 36 and the second discharge roller 37 are respectively disposed at an upstream position and a downstream position sandwiching a disposing position B of the cutter 10.

The third discharge roller 40 is disposed downstream of the merging position C in the branch path 200. The first discharge roller 36, the second discharge roller 37, and the third discharge roller 40 discharge the sheet P from the inside of the device main body 2 to the outside of the device main body 2.

The image forming unit 4 is an example of a process unit that forms an image on the sheet P, and is accommodated in the device main body 2. The image forming unit 4 includes a drum cartridge 6 and a laser unit 7. The drum cartridge 6 includes the photosensitive drum 61, a toner container 62, a feed roller 63, a developing roller 64, a charger 65, a transfer roller TR, and a pinch roller 66.

The drum cartridge 6 can be removed from the device main body 2 by opening the front cover 20. The pinch roller 66 of the drum cartridge 6 is located to face the registration roller 34. The pinch roller 66 is configured to rotate following the rotation of the registration roller 34 to convey the sheet P together with the registration roller 34.

The photosensitive drum 61 is configured to rotate in a clockwise direction by the drive force transmitted from the main motor 108 (see FIG. 2) to convey the sheet P in the conveying direction. The toner container 62 contains a toner. The feed roller 63 is configured to feed the toner in the toner container 62 to the developing roller 64. The charger 65 is a scorotron charger and uniformly charges a surface of the photosensitive drum 61. The charger 65 may be a charging roller.

The transfer roller TR is disposed at a position facing the photosensitive drum 61. The transfer roller TR is an example of a transfer unit, and a transfer nip TN is formed between the transfer roller TR and the photosensitive drum 61 in the conveying path 201. A transfer belt may be used as an example of the transfer unit instead of the transfer roller TR.

The device main body 2 includes the laser unit 7 at an upper portion inside thereof. The laser unit 7 includes a polygon mirror 131, a laser emitter 132 (see FIG. 2), a lens (not shown), a reflective mirror (not shown), and the like. In the laser unit 7, a laser beam (see a two-dot chain line) based on image data emitted from the laser emitter 132 is scanned at high speed on the surface of the photosensitive drum 61 to expose the surface of the photosensitive drum 61.

The surface of the photosensitive drum 61 is exposed by the laser unit 7, and an electrostatic latent image based on the image data is formed thereon. The developing roller 64 feeds the toner to the electrostatic latent image formed on the surface of the photosensitive drum 61 to form a toner image on the surface of the photosensitive drum 61.

A transfer voltage is applied to the transfer roller TR from a voltage application unit (not shown). The transfer roller TR conveys the sheet P between the transfer roller TR and the photosensitive drum 61, thereby transferring the toner image formed on the surface of the photosensitive drum 61 to the sheet S passing through the transfer nip TN. In other words, the transfer roller TR transfers the toner fed on the photosensitive drum 61 to the sheet P. In this way, the image is formed on the sheet P.

The fixing device 5 is disposed downstream of the image forming unit 4 in the conveying path 201. The fixing device 5 is an example of a fixing unit. The fixing device 5 includes a heating roller 51, a pressure roller 52, a heater 53, a temperature sensor 54, and a discharge sensor 112.

The heating roller 51 is an example of a heating rotation body, and is configured to heat the sheet P. The pressure roller 52 is an example of a pressure rotation body, and is configured to form a nip portion N between the pressure roller 52 and the heating roller 51 to pressurize the sheet P. The pressure roller 52 is configured to rotate in a counterclockwise direction by the drive force of the main motor 108. The heating roller 51 is configured to rotate following the rotation of the pressure roller 52 in the clockwise direction.

The heating roller 51 may rotate in the clockwise direction by the drive force of the main motor 108, and the pressure roller 52 may rotate following the rotation of the heating roller 51 in the counterclockwise direction. Alternatively, the drive force of the main motor 108 may be transmitted to both the heating roller 51 and the pressure roller 52, the heating roller 51 may rotate in the clockwise direction, and the pressure roller 52 may rotate in the counterclockwise direction.

The heater 53 is, for example, a halogen heater, and is configured to heat the heating roller 51. The temperature sensor 54 is provided in the fixing device 5 and is configured to detect a temperature of the heating roller 51. The temperature sensor 54 is configured to output a signal corresponding to the detected temperature to a CPU 101 (see FIG. 2).

The fixing device 5 is configured to heat the sheet P by the heating roller 51 and rotate the pressure roller 52, so that the sheet P is conveyed while being pressurized by the heating roller 51 and the pressure roller 52, and thus the image formed on the sheet P by the image forming unit 4 is fixed onto the sheet P.

The fixing device 5 includes the heating roller 51, the pressure roller 52, and the heater 53, but is not limited thereto. For example, the fixing device 5 may include a heater, a nip plate configured to receive radiant heat from the heater, a heating belt configured to rotate around the nip plate, and a pressure roller. In this case, the heating belt is an example of the heating rotation body.

Further, the fixing device 5 may include a substrate on which a heat generating pattern is formed, a belt configured to rotate around the substrate, and a pressure roller, and the substrate may be in contact with the belt. In this case, the belt is an example of the heating rotation body. Further, the fixing device 5 may include a heating roller, a heater, and a pressure belt. In this case, the pressure belt is an example of the pressure rotation body.

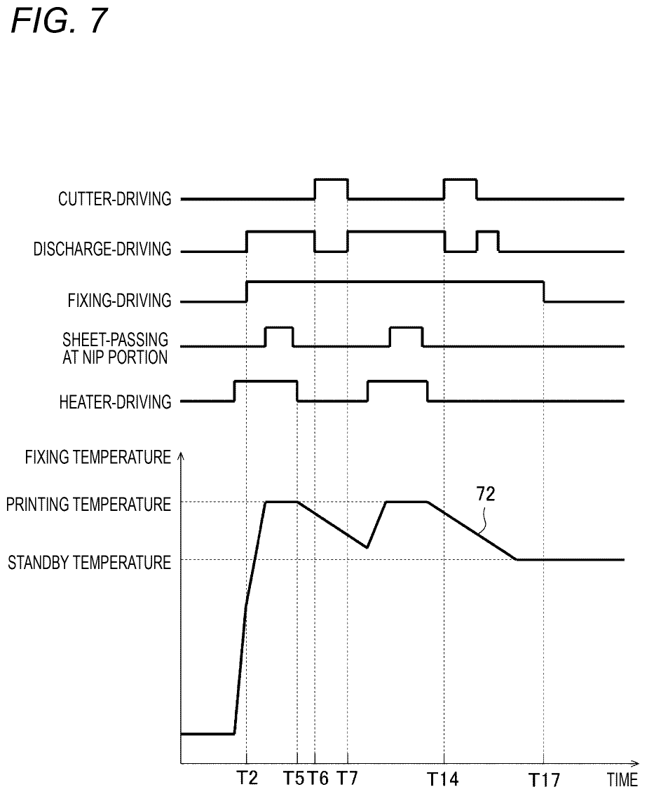

The cutter 10 is disposed at the disposing position B of the cutter 10 located downstream of the fixing device 5 and at the merging position C in the conveying path 201. The cutter 10 is a known cutter mechanism capable of cutting the sheet P. The cutter 10 includes, for example, a blade 75 (see FIG. 2), a fixed blade, a cutter carriage 11 (see FIG. 7), and a cutting motor 106 (see FIG. 2). The cutter 10 may have a pair of upper and lower blades 75.

The blade 75 is, for example, a rotatable round blade, and is held by the cutter carriage 11. The fixed blade is fixed to a frame provided inside the device main body 2 to extend in a left-right direction. The cutter carriage 11 can reciprocate, by a drive force of the cutting motor 106, in a width direction of the sheet P along a rail 12 (see FIG. 7) provided to extend in the left-right direction in the device main body 2.

When the sheet P is located at the disposing position B of the cutter 10, the cutter carriage 11 moves along the width direction of the sheet P, and thus the sheet P is cut by being sandwiched between the blade 75 and the fixed blade.

### [Electrical Configuration of Image Forming Device 1]

Next, an electrical configuration of the image forming device 1 will be described with reference to FIG. 2. FIG. 2 is a block diagram showing the electrical configuration of the image forming device 1. As shown in FIG. 2, the image forming device 1 further includes an application specific integrated circuit (ASIC) 105, a read only memory (ROM) 102, a random access memory (RAM) 103, a non-volatile random access memory (NVRAM) 104, a pre-registration sensor 110, a post-registration sensor 111, the discharge sensor 112, a temperature and humidity sensor 113, and a communication interface (I/F) 130.

The central processing unit (CPU) 101 is mounted on the ASIC 105. The CPU 101 is an example of a controller, and is configured to perform an overall control on respective parts of the image forming device 1. The ASIC 105 is electrically connected to the ROM 102, the RAM 103, the NVRAM 104, the cutting motor 106, the electromagnetic clutch 107, the main motor 108, and the discharge motor 140. Further, the ASIC 105 is electrically connected to the pre-registration sensor 110, the post-registration sensor 111, the discharge sensor 112, the temperature and humidity sensor 113, the operation panel 120, the communication I/F 130, the fixing device 5, and the laser unit 7.

The ROM 102 is an example of a storage unit. The ROM 102 is configured to store various control programs, various settings, and the like for controlling the image forming device 1. Specifically, the ROM 102 stores information on a printing temperature of the heating roller 51 and the pressure roller 52 when the image is fixed to the sheet P. The printing temperature is an example of a first temperature. That is, in the present embodiment, a temperature of the fixing unit refers to temperatures of the heating roller 51 and the pressure roller 52. However, the temperature of the fixing unit may be only the temperature of the heating roller 51, and the controller may control the temperature of the entire fixing unit or a temperature of a part of the fixing unit (for example, a nip portion N) by controlling the temperature of the heating roller 51.

Further, the ROM 102 is configured to store information on a standby temperature of the heating roller 51 and the pressure roller 52 at the time of waiting for the conveyance of the sheet P. The standby temperature is an example of a second temperature. Further, the ROM 102 is configured to store information on a sheet feed-enabled temperature of the heating roller 51 and the pressure roller 52 when the sheet P is conveyed from the feed tray 21. The sheet feed-enabled temperature is an example of a sheet feed temperature. The ROM 102 is configured to store information such as a high temperature. The high temperature is an example of a third temperature.

The RAM 103 is used as a work area in which various control programs are read, and a storage area for temporarily storing image data included in a print job. The CPU 101 is configured to control the respective parts of the image forming device 1 while storing a process result in the RAM 103 or the NVRAM 104 in accordance with the control program read from the ROM 102 and signals output from various sensors.

The cutting motor 106 is an example of a cutter drive source. The CPU 101 is configured to drive the cutting motor 106 to move the cutter carriage 11, so that the blade 75 is moved in the width direction of the sheet P to cut the sheet P.

The main motor 108 is configured to transmit the drive force to the conveying unit 3, the pressure roller 52, and the drum cartridge 6. In a case where the CPU 101 drives the main motor 108 to rotate in a forward direction, the drive force is transmitted to the pressure roller 52, the photosensitive drum 61, the developing roller 64, the pickup roller 31, and the registration roller 34 from the main motor 108.

Then, the pressure roller 52, the photosensitive drum 61, the developing roller 64, the pickup roller 31, and the registration roller 34 rotate in a direction in which the sheet P is conveyed in the conveying direction. The main motor 108 is configured to transmit the drive force to the photosensitive drum 61, the developing roller 64, and the like, and thus it is possible to collectively drive the photosensitive drum 61, the developing roller 64, and the like by the main motor 108.

On the other hand, even when the CPU 101 drives the main motor 108 to rotate in a reverse direction, the drive force is not transmitted to the pressure roller 52, the drum cartridge 6, the pickup roller 31, and the registration roller 34. The CPU 101 may control the main motor 108 to rotate at least one of the heating roller 51 and the pressure roller 52 to convey the sheet P.

The electromagnetic clutch 107 is an example of a clutch, and is controlled by the CPU 101. The electromagnetic clutch 107 is configured to switch between a transmission state in which the drive force is transmitted from the main motor 108 to the pickup roller 31, and a non-transmission state in which the drive force is not transmitted from the main motor 108 to the pickup roller 31.

Specifically, the CPU 101 turns on the electromagnetic clutch 107 so that the electromagnetic clutch 107 is in the transmission state in which the drive force of the main motor 108 is transmitted to the pickup roller 31. On the other hand, the CPU 101 turns off the electromagnetic clutch 107 so that the electromagnetic clutch 107 is in the non-transmission state in which the drive force of the main motor 108 is not transmitted to the pickup roller 31. When the image forming device 1 is activated, the CPU 101 sets the electromagnetic clutch 107 to OFF.

The discharge motor 140 is configured to transmit a drive force to the first discharge roller 36, the second discharge roller 37, and the third discharge roller 40. The CPU 101 is configured to drive the discharge motor 140 to rotate in the forward direction, so that the drive force is transmitted to the first discharge roller 36, the second discharge roller 37, and the third discharge roller 40. Then, the first discharge roller 36, the second discharge roller 37, and the third discharge roller 40 rotate in a direction in which the sheet P is conveyed in the conveying direction.

The pre-registration sensor 110 is a sensor that is disposed upstream of the registration roller 34 in the conveying path 201 and configured to detect that the sheet P passes. As the pre-registration sensor 110, a sensor provided with an actuator that swings due to the contact of the sheet P, an optical sensor, or the like can be used. The pre-registration sensor 110 is configured to outputs an ON signal in a state where the sheet P passes, and output an OFF signal in a state where the sheet P does not pass. A detection signal from the pre-registration sensor 110 is output to the CPU 101.

The post-registration sensor 111 is an example of a first sheet sensor, and is a sensor that is disposed upstream of the fixing device 5 in the conveying path 201, specifically, disposed between the photosensitive drum 61 and the registration roller 34 in the conveying direction, and that is configured to detect passage of the sheet P. The post-registration sensor 111 has the same configuration as that of the pre-registration sensor 110. A detection signal from the post-registration sensor 111 is output to the CPU 101.

The discharge sensor 112 is an example of a second sheet sensor, and is a sensor that is disposed between the heating roller 51 of the fixing device 5 and the roller 35 in the conveying path 201, that is, disposed downstream of the nip portion N, and that is configured to detect passage of the sheet P. The discharge sensor 112 has the same configuration as that of the pre-registration sensor 110.

A detection signal from the discharge sensor 112 is output to the CPU 101. The discharge sensor 112 is configured to output an OFF signal before the sheet P passes through the discharge sensor 112, and output an ON signal while the sheet P having passed through the nip portion N is passing through the discharge sensor 112. That is, in a case where the leading end of the sheet P in the conveying direction enters the discharge sensor 112, the discharge sensor 112 is turned on, and thereafter in a case where a trailing end PL (see FIG. 6) of the sheet P is discharged from the discharge sensor 112, the discharge sensor 112 is turned off.

The temperature and humidity sensor 113 is a sensor that is configured to detect a temperature and a humidity outside the device main body 2. The temperature and humidity sensor 113 is disposed, for example, on a side surface of the device main body 2. The temperature and humidity sensor 113 is configured to output a signal corresponding to the detected temperature and humidity to the CPU 101. Instead of the temperature and humidity sensor 113, a temperature sensor for detecting the temperature outside the device main body 2 and a humidity sensor for detecting the humidity outside the device main body 2 may be disposed in the device main body 2.

The operation panel 120 is disposed on an upper surface of the device main body 2. The operation panel 120 includes, for example, a touch panel in which a touch pad and a display are integrally formed, and a key button portion. The operation panel 120 is configured to receive an operation by a user and outputs received information to the CPU 101. The user can set whether to cut the sheet P, for example, by operating the operation panel 120.

The communication I/F 130 is connected to a network such as a LAN, and can be connected to an external device such as a PC in which a driver for the image forming device 1 is incorporated. The CPU 101 is configured to receive a print job via the communication I/F 130. The print job includes the image data for image formation, the size and type of the sheet P used for the image formation, and various kinds of information necessary for forming the image on the sheet P.

### [Flow of Print Control by CPU 101]

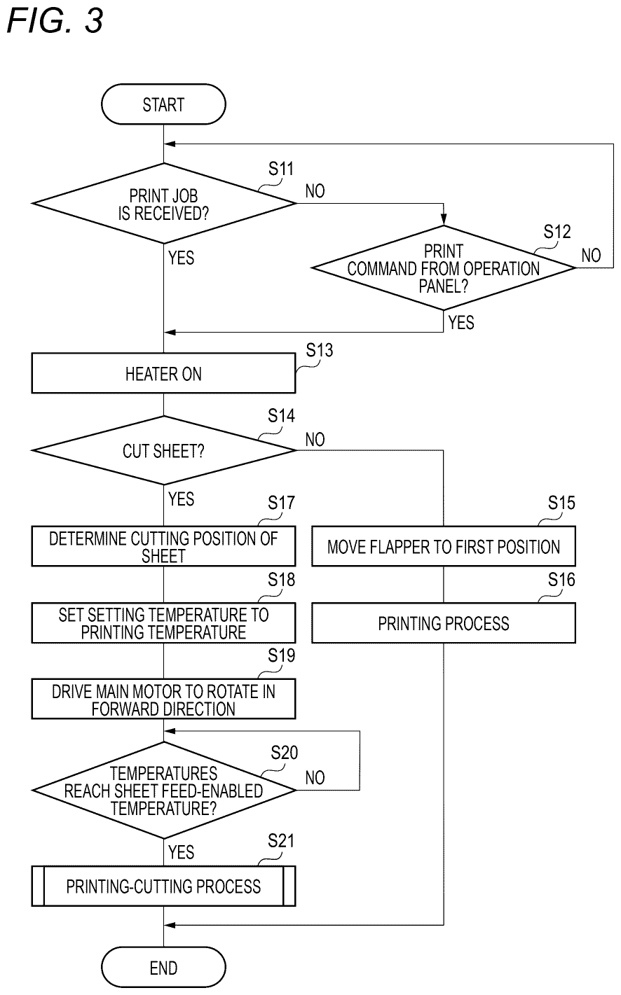

Next, an example of a flow of a print control performed by the CPU 101 of the image forming device 1 will be described with reference to FIGS. 3 to 6. FIG. 3 is a main flowchart showing the example of the flow of the print control performed by the CPU 101 of the image forming device 1. In the following description, a case is described as an example in which simplex printing is performed on the sheet P having the A4 size and then a cutting process is performed on the sheet P to obtain the first sheet P1 and the second sheet P2 (see FIG. 6) each having the A5 size.

As shown in FIG. 3, in S11, the CPU 101 determines whether the print job is received via the communication I/F 130. Then, when the CPU 101 determines that the print job is received via the communication I/F 130 (S11: YES), the CPU 101 proceeds to the process of S13 to be described later.

On the other hand, when the CPU 101 determines that the print job is not received via the communication I/F 130 (S11: NO), the CPU 101 proceeds to the process of S12. In S12, the CPU 101 determines whether an input of a print command is received via the operation panel 120. Then, when the CPU 101 determines that the input of the print command is not received via the operation panel 120 (S12: NO), the CPU 101 executes the process of S11 again.

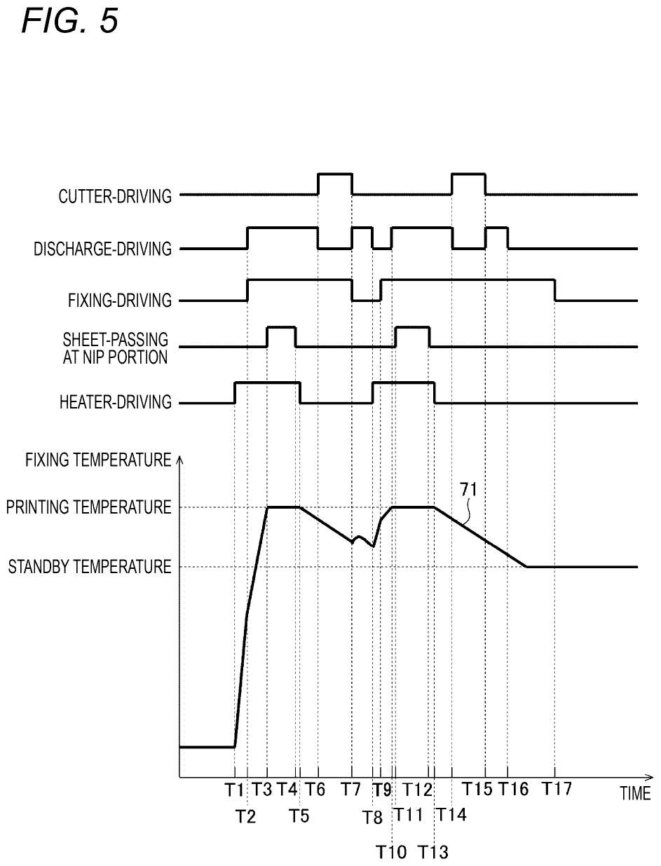

On the other hand, when the CPU 101 determines that the input of the print command is received via the operation panel 120 (S12: YES), the CPU 101 proceeds to the process of S13. In S13, the CPU 101 starts to drive the heater 53. For example, as shown in FIG. 5, the CPU 101 starts to drive the heater 53 at a time T1. That is, energization to the heater 53 is started.

After the energization to the heater 53 is started, in S14, the CPU 101 determines whether to cut the sheet P. That is, when it is instructed in the input print job that cutting of the sheet P is required, the CPU 101 determines to cut the sheet P (S14: YES), and proceeds to the process of S17. On the other hand, when the cutting of the sheet P is not required (S14: NO), the CPU 101 proceeds to the process of S15.

In S15, the CPU 101 moves the flapper 8 to the first position and proceeds to the process of S16. When the flapper 8 moves to the first position, the sheet P is distributed to the branch path 200. In a case in which the flapper 8 is located at the first position at a start time point of S15, the CPU 101 maintains a state in which the flapper 8 is located at the first position, and proceeds to the process of S16.

In S16, the CPU 101 executes a printing process without cutting the sheet P. Although a detailed description of the printing process without cutting the sheet P is omitted, the leading end of the sheet on which the toner image has been formed and fixed is guided, by the flapper 8, to the branch path 200 in which the third discharge roller 40 is present. The sheet guided to the branch path 200 is discharged onto the discharge tray 22 by rotation of the third discharge roller 40.

In S17, the CPU 101 determines a cutting position A for cutting the sheet P into two equal portions and stores the cutting position A in the RAM 103. Specifically, as shown in FIG. 6, the CPU 101 determines the cutting position A, at which the sheet P having the A4 size is bisected into the first sheet P1 and the second sheet P2 each having the same length in the conveying direction, as a position for a length L2 in the conveying direction from the leading end, and stores the position in the RAM 103.

For example, the length L2 is calculated based on the amount of conveyance of the sheet P detected by an encoder (not shown) until the post-registration sensor 111 detects the leading end of the sheet P and then the post-registration sensor 111 detects the trailing end PL of the sheet P.

In S18, the CPU 101 reads, from the ROM 102, the printing temperature of the heating roller 51 and the pressure roller 52 when the image is fixed to the sheet P. Then, the CPU 101 sets the temperature of the heating roller 51 to the printing temperature, for example, to reach about 190° C., starts a control of a voltage applied to the heater 53, and then proceeds to the process of S19.

In S19, the CPU 101 drives the main motor 108 to rotate in the forward direction and then proceeds to the process of S20. Accordingly, the pressure roller 52, the photosensitive drum 61, the developing roller 64, and the registration roller 34 rotate in the direction in which the sheet P is conveyed in the conveying direction. As a result, for example, as shown in FIG. 5, when the pressure roller 52 or the heating roller 51 of the fixing device 5 is driven to rotate at a time T2, a temperature rise rate of a fixing temperature between the heating roller 51 and the pressure roller 52, that is, at the nip portion N becomes slightly slow.

In S20, the CPU 101 determines whether the temperature of each of the heating roller 51 and the pressure roller 52 reaches the sheet feed-enabled temperature via the temperature sensor 54. The sheet feed-enabled temperature is a temperature at which the drive force of the main motor 108 can be transmitted to the pickup roller 31, and is, for example, 170° C. Then, when the CPU 101 determines that the temperature of each of the heating roller 51 and the pressure roller 52 does not reach the sheet feed-enabled temperature via the temperature sensor 54 (S20: NO), the CPU 101 executes the process of S20 again.

On the other hand, when the CPU 101 determines that the temperature of each of the heating roller 51 and the pressure roller 52 reaches the sheet feed-enabled temperature via the temperature sensor 54 (S20: YES), the CPU 101 proceeds to the process of S21. In S21, the CPU 101 executes a sub process of a printing-cutting process, and then ends the process.

### [Sub Process of Printing-Cutting Process]

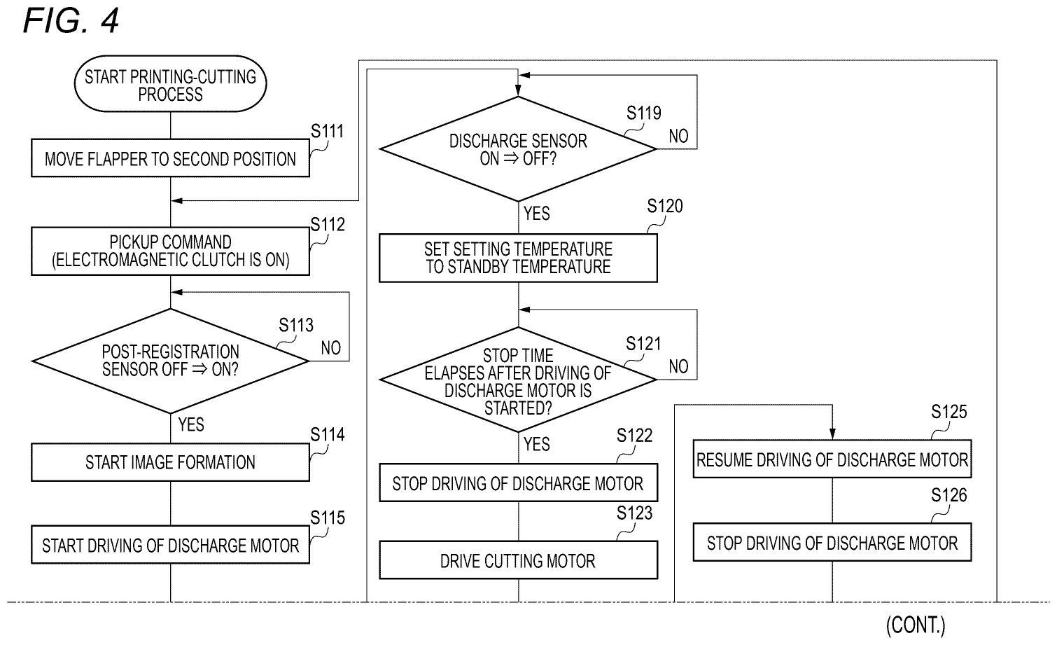

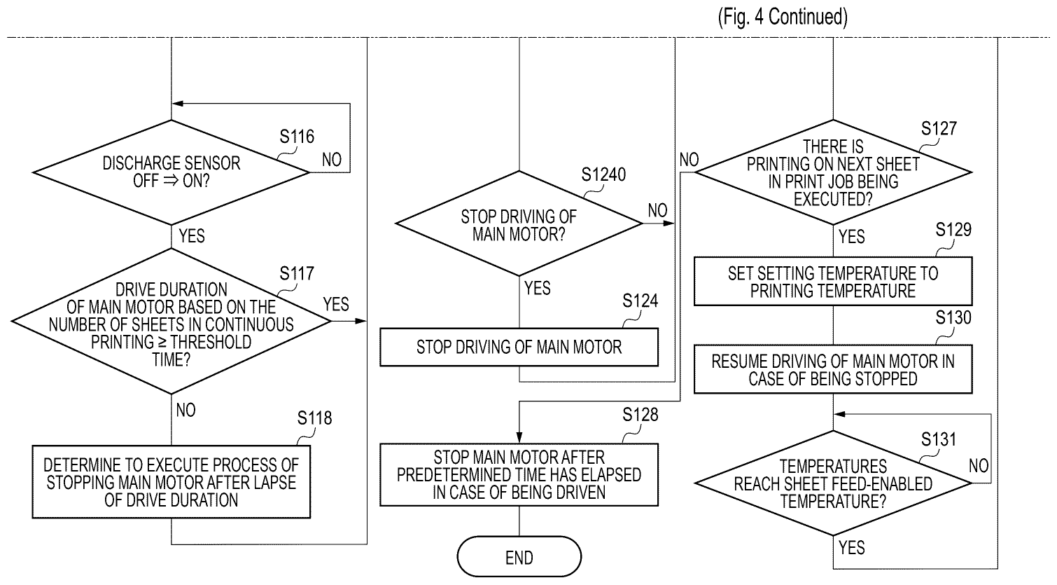

Next, an example of a flow of the printing-cutting process executed by the CPU 101 in S21 will be described with reference to FIGS. 4 to 6. FIG. 4 is a sub flowchart showing the example of the flow of the printing-cutting process. FIG. 5 is a timing chart showing an example of a relation between a drive timing of each drive unit and a temperature of the fixing device 5. FIG. 6 is a diagram for explaining the cutting of the sheet P passing through the nip portion N.

As shown in FIG. 4, in S111, the CPU 101 drives the drive motor (not shown) to move the flapper 8 to the second position, and proceeds to the process of S112. When the flapper 8 moves to the second position, the sheet P is distributed to the conveying path 201. In a case where the flapper 8 is located at the second position at a start time point of S111, the CPU 101 maintains a state in which the flapper 8 is located at the second position, and proceeds to the process of S112.

In S112, the CPU 101 executes a pickup command for picking up the sheet P in the feed tray 21 by the pickup roller 31. Specifically, the CPU 101 turns on the electromagnetic clutch 107 and sets the electromagnetic clutch 107 to be in the transmission state in which the drive force of the main motor 108 is transmitted to the pickup roller 31. Thereafter, the CPU 101 proceeds to the process of S113.

In S113, the CPU 101 determines whether the detection signal input from the post-registration sensor 111 changes from “OFF” to “ON”. Specifically, the CPU 101 determines that the detection signal becomes “ON” by detecting the leading end of the conveyed sheet P by the post-registration sensor 111 and acquiring the detection signal transmitted from the post-registration sensor 111.

Then, when the detection signal input from the post-registration sensor 111 does not change from “OFF” to “ON” (S113: NO), the CPU 101 executes the process of S113 again. On the other hand, when the detection signal input from the post-registration sensor 111 changes from “OFF” to “ON” (S113: YES), the CPU 101 proceeds to the process of S114.

In S114, the CPU 101 starts the image formation on the sheet P by the image forming unit 4. Specifically, the CPU 101 controls the photosensitive drum 61 and the transfer roller TR to form the image based on the image data on the sheet P. That is, the CPU 101 transfers the toner image formed on the photosensitive drum 61 to the sheet P by the transfer roller TR. Then, the image formed on the sheet P is fixed to the sheet P by the fixing device 5.

Subsequently, in S115, the CPU 101 starts the rotation of the discharge motor 140 in the forward direction, rotates the first discharge roller 36 and the second discharge roller 37, and proceeds to the process of S116. Accordingly, for example, as shown in FIG. 5, discharge-driving for rotating the first discharge roller 36 and the second discharge roller 37 is started at the time T2.

Thus, as in the processes of S113 and S115, the CPU 101 controls the discharge motor 140 based on a time point when the post-registration sensor 111 detects the sheet P. The post-registration sensor 111 is disposed between the photosensitive drum 61 and the registration roller 34. Further, the registration roller 34 is a conveying roller closest to the first discharge roller 36 and the second discharge roller 37 in the conveying direction among the plurality of conveying rollers disposed upstream of the photosensitive drum 61. Accordingly, the post-registration sensor 111 is disposed at a position as close as possible to the first discharge roller 36 and the second discharge roller 37 on an upstream side of the photosensitive drum 61.

Further, after the post-registration sensor 111 detects the sheet P, the sheet P reaches the first discharge roller 36. Therefore, the CPU 101 controls the discharge motor 140 based on the time point when the post-registration sensor 111 detects the sheet P, and thus it is possible to start driving of the discharge motor 140 at an appropriate timing and start rotation-driving of the first discharge roller 36 and the second discharge roller 37.

In S116, the CPU 101 determines whether the detection signal input from the discharge sensor 112 changes from “OFF” to “ON”. Specifically, the CPU 101 determines that the detection signal becomes “ON” by detecting the leading end of the conveyed sheet P by the discharge sensor 112 and acquiring the detection signal transmitted from the discharge sensor 112.

For example, as shown in FIG. 5, the CPU 101 determines that the detection signal input from the discharge sensor 112 changes from “OFF” to “ON” at a time T3. At this time, the CPU 101 controls the discharge motor 140 and rotates the first discharge roller 36 and the second discharge roller 37 to convey the sheet P having passed through the nip portion N.

Then, when the detection signal input from the discharge sensor 112 does not change from “OFF” to “ON” (S116: NO), the CPU 101 executes the process of S116 again. On the other hand, when the detection signal input from the discharge sensor 112 changes from “OFF” to “ON” (S116: YES), the CPU 101 proceeds to the process of S117.

In S117, the CPU 101 determines whether a drive duration of the main motor 108 based on the number of sheets in continuous printing of a print job is equal to or larger than a threshold time. The number of sheets in the continuous printing is counted, for example, based on the number of sheets P having passed through a sensor position of the pre-registration sensor 110 or the like. Further, the number of sheets in the continuous printing may be the number of printed sheets specified in one print job, or may be the total number of printed sheets when the sheets P are continuously printed over a plurality of print jobs. In addition, the number of sheets in the continuous printing may be the number of printed sheets in a case in which an interval between print jobs is within a predetermined time even when printing is interrupted during the print jobs. The drive duration of the main motor 108 based on the number of sheets in the continuous printing is associated as shown in Table 1 below.

TABLE 1

| THE NUMBER OF SHEETS IN | DRIVE | |
|---|---|---|
| CONTINUOUS PRINTING | DURATION | |
| 60 OR MORE | 30 | SECONDS |
| 30 TO 59 | 20 | SECONDS |
| 10 TO 29 | 15 | SECONDS |
| LESS THAN 10 | 3 | SECONDS |

When the number of sheets in the continuous printing is 60 or more, the drive duration of the main motor 108 is 30 seconds. When the number of sheets in the continuous printing is 30 to 59, the drive duration of the main motor 108 is 20 seconds. When the number of sheets in the continuous printing is 10 to 29, the drive duration of the main motor 108 is 15 seconds. When the number of sheets in the continuous printing is less than 10, the drive duration of the main motor 108 is 3 seconds.

Accordingly, when the CPU 101 executes the continuous printing in which a plurality of sheets P are continuously printed, the CPU 101 sets the drive duration of the main motor 108 according to the number of the printed sheets P. Further, the drive duration in a case in which each of the heating roller 51 and the pressure roller 52 is provided with a layer made of rubber is preferably larger than the drive duration in a case in which each of the heating roller 51 and the pressure roller 52 is not provided with the layer and a surface thereof is coated.

The threshold time is, for example, 20 seconds. Then, when the CPU 101 determines that the drive duration of the main motor 108 based on the number of sheets in the continuous printing of the print job is equal to or larger than the threshold time (S117: YES), the CPU 101 proceeds to the process of S119 to be described later.

On the other hand, when the CPU 101 determines that the drive duration of the main motor 108 based on the number of sheets in the continuous printing of the print job is less than the threshold time (S117: NO), the CPU 101 proceeds to the process of S118. In S118, the CPU 101 determines to execute the process of stopping the main motor 108 after the elapse of the drive duration of the main motor 108, and proceeds to the process of S119.

The CPU 101 determines whether to execute the process of S118 based on the process of S117, and thus the CPU 101 sets the drive duration of the main motor 108 based on a time point when the discharge sensor 112 detects the sheet P in S116.

The discharge sensor 112 is disposed downstream of the nip portion N in the conveying direction. Therefore, the discharge sensor 112 detects the sheet P after the sheet P reaches the nip portion N. Therefore, the CPU 101 sets the drive duration of the main motor 108 based on the time point when the discharge sensor 112 detects the sheet P, and thus it is possible to stop driving of the main motor 108 at an appropriate timing to stop the heating roller 51.

In S119, the CPU 101 determines whether the detection signal input from the discharge sensor 112 changes from “ON” to “OFF”. Specifically, when the CPU 101 detects the leading end of the conveyed sheet P by the discharge sensor 112 and then discharges the trailing end of the sheet P, the detection signal transmitted from the discharge sensor 112 cannot be acquired, and thus the CPU 101 determines that the detection signal becomes “OFF”.

Then, when the detection signal input from the discharge sensor 112 does not change from “ON” to “OFF” (S119: NO), the CPU 101 executes the process of S119 again. On the other hand, when the detection signal input from the discharge sensor 112 changes from “ON” to “OFF” (S119: YES), the CPU 101 determines that the discharge sensor 112 detects passage completion of the sheet P, and proceeds to the process of S120.

For example, as shown in FIG. 5, when the detection signal input from the discharge sensor 112 changes from “ON” to “OFF” at a time T4, the CPU 101 determines that the discharge sensor 112 detects the passage completion of the sheet P. That is, the CPU 101 determines that the sheet trailing end PL of the sheet P has passed through the nip portion N.

In S120, the CPU 101 reads the standby temperature of the heating roller 51 and the pressure roller 52 from the ROM 102 at the time of waiting for the conveyance of the sheet P. Then, the CPU 101 sets the temperature of the heating roller 51 to the standby temperature, for example, to be lowered to about 130° C., starts the control of the voltage applied to the heater 53, and then proceeds to the process of S121. The standby temperature is a temperature lower than the printing temperature. For example, as shown in FIG. 5, the CPU 101 stops driving of the heater 53 at a time T5. At the timing of the time T5, the passage of the sheet P between the heating roller 51 and the pressure roller 52, that is, through the nip portion N is completed.

By the process of S120, the CPU 101 controls the heater 53 such that the temperature of the heating roller 51 becomes the standby temperature lower than the printing temperature, based on the time point when the discharge sensor 112 detects the passage completion of the sheet P. When the discharge sensor 112 detects the passage of the sheet P, the sheet P has passed through the nip portion N, and thus it is preferable to lower the temperature of the heating roller 51. In this case, the CPU 101 controls the heater 53 such that the temperature of the heating roller 51 becomes the standby temperature lower than the printing temperature, and thus it is possible to restrain the heating roller 51 and the pressure roller 52 from locally rising in temperature.

In step S121, the CPU 101 starts to measure an elapsed time from a time point when the rotation of the discharge motor 140 in the forward direction is started. Subsequently, the CPU 101 determines whether the elapsed time from the time point when the rotation of the discharge motor 140 in the forward direction is started reaches a predetermined stop time, that is, whether the predetermined stop time has elapsed. The predetermined stop time is an elapsed time from the time point when the rotation of the discharge motor 140 in the forward direction is started until the cutting position A (see FIG. 6) of the sheet P reaches the disposing position B (see FIG. 1) of the cutter 10. The predetermined stop time is stored in the ROM 102 in advance. For example, the predetermined stop time is an elapsed time from the time T2 to a time T6 shown in FIG. 5.

Then, when the CPU 101 determines that the elapsed time from the time point when the rotation of the discharge motor 140 in the forward direction is started does not reach the predetermined stop time (S121: NO), the CPU 101 executes the process of S121 again. On the other hand, when the CPU 101 determines that the elapsed time from the time point when the rotation of the discharge motor 140 in the forward direction is started reaches the predetermined stop time (S121: YES), the CPU 101 proceeds to the process of S122.

In S122, the CPU 101 stops the discharge motor 140 and then proceeds to the process of S123. For example, as shown in FIG. 5, the CPU 101 stops the discharge motor 140 to stop the discharge-driving at the time T6. Accordingly, since the first discharge roller 36 and the second discharge roller 37 stop in a state of sandwiching the sheet P, the sheet P stops in a state in which the cutting position A is located at the disposing position B of the cutter 10. That is, the CPU 101 stops the first discharge roller 36 and the second discharge roller 37 when the cutting position A on the sheet P reaches the disposing position B of the cutter 10.

By the processes of S121 and S122, the CPU 101 stops the discharge motor 140 to stop the sheet P when a predetermined time has elapsed from the start of driving of the discharge motor 140. Accordingly, the CPU 101 can appropriately control the first discharge roller 36 and the second discharge roller 37 such that the cutting position A on the sheet P reaches the disposing position B of the cutter 10.

In S123, the CPU 101 drives the cutting motor 106 to reciprocate the blade 75 held by the cutter carriage in the width direction of the sheet P. The CPU 101 starts driving of the cutting motor 106 and then proceeds to the process of S1240. For example, as shown in FIG. 5, the CPU 101 starts the driving of the cutting motor 106 at the time T6 to start cutter-driving, and stops the cutting motor 106 at a time T7.

Thus, the sheet P is cut into two equal portions, that is, the first sheet P1 and the second sheet P2. Here, after stopping the first discharge roller 36 and the second discharge roller 37, the CPU 101 starts the cutting of the sheet P with the cutter 10 while driving the main motor 108 to rotate the heating roller 51 or the pressure roller 52.

Here, an example of the fixing temperature at the nip portion N between the heating roller 51 and the pressure roller 52 will be described with reference to FIG. 5. A graph 71 indicates a change in the fixing temperature at the nip portion N between the heating roller 51 and the pressure roller 52. When the CPU 101 sets a temperature of the heater 53 to the standby temperature and stops the driving of the heater 53 at the time T5, the fixing temperature at the nip portion N starts to decrease from the time T5 as shown in the graph 71.

Then, the CPU 101 is in a state of driving the main motor 108 to rotate the heating roller 51 or the pressure roller 52 at the time point when the CPU 101 drives the cutting motor 106 at the time T6. Therefore, the fixing temperature at the nip portion N at the time T6 is lower than the fixing temperature at the nip portion N at the time T5.

Therefore, even after the sheet P passes through the nip portion N at the time T4 and the first discharge roller 36 and the second discharge roller 37 stop at the time T6, the heating roller 51 and the pressure roller 52 are rotating. Therefore, it is possible to restrain the heating roller 51 and the pressure roller 52 from locally rising in temperature at the time T6. Thus, it is possible to restrain a decrease in the durability of the fixing device 5.

In S1240, the CPU 101 determines whether to stop the main motor 108 after the elapse of the drive duration of the main motor 108 by determining whether the process of S118 is executed. When the process of S118 is executed (S1240: YES), the CPU 101 stops the main motor 108 at a time point when the set drive duration of the main motor 108 has elapsed (S124), and then proceeds to the process of S125.

For example, as shown in FIG. 5, the CPU 101 stops the heating roller 51 and the pressure roller 52 of the fixing device 5 by stopping the driving of the main motor 108 at the time T7 so as to stop fixing-driving. Accordingly, when the main motor 108 is not required to be driven, the driving of the main motor 108 is stopped, and thus it is possible to improve the durability of the heating roller 51 and the pressure roller 52 of the fixing device 5 or the like driven by the main motor 108.

Further, when the process of S118 is not executed in S1240 (S1240: NO), the CPU 101 continues the driving of the main motor 108 without stopping the main motor 108, and proceeds to the process of S125. That is, when the CPU 101 determines that the drive duration of the main motor 108 is equal to or larger than the threshold time, the CPU 101 continues the driving of the main motor 108 after starting the driving of the cutting motor 106.

In step S125, the CPU 101 resumes the driving of the discharge motor 140 to rotate the first discharge roller 36 and the second discharge roller 37 and discharge the cut first sheet P1 and second sheet P2, and then proceeds to the process of S126. For example, as shown in FIG. 5, the discharge-driving for rotating the first discharge roller 36 and the second discharge roller 37 is resumed at the time T7.

In S126, the CPU 101 stops the driving of the discharge motor 140 and then proceeds to the process of S127. For example, as shown in FIG. 5, the CPU 101 stops the discharge motor 140 to stop the discharge-driving at a time T8.

By the processes of S123 to S126, after cutting the sheet P with the cutter 10, the CPU 101 controls the discharge motor 140 to rotate the first discharge roller 36 and the second discharge roller 37 and discharge the cut sheet P. Then, after discharging the cut sheet P, the CPU 101 stops the first discharge roller 36 and the second discharge roller 37. Accordingly, when the first discharge roller 36 and the second discharge roller 37 are not required to be driven, the first discharge roller 36 and the second discharge roller 37 are stopped, and thus it is possible to restrain noise caused by the first discharge roller 36 and the second discharge roller 37.

In S127, the CPU 101 determines whether there is image data for the printing on the next sheet P in the print job being executed. Then, when the CPU 101 determines that there is no image data for the printing on the next sheet P in the print job being executed (S127: NO), the CPU 101 proceeds to the process of S128. The next sheet P refers to the sheet P picked up from the feed tray 21 by the pickup roller 31 next to the sheet P discharged by the first discharge roller 36 and the second discharge roller 37.

In S128, when the main motor 108 is being driven, the CPU 101 stops the main motor 108 after a predetermined time, for example, about 2 seconds to 3 seconds have elapsed, ends the flow shown in FIG. 4, and returns to the main flowchart. When the main motor 108 is not being driven, the CPU 101 ends the flow shown in FIG. 4 and returns to the main flowchart. The timing of “after a predetermined time has elapsed” is also the timing of “after the elapse of the drive duration”. On the other hand, when the CPU 101 determines that there is the image data for the printing on the next sheet P in the print job being executed (S127: YES), the CPU 101 proceeds to the process ofS 129.

In S129, the CPU 101 reads, from the ROM 102, the printing temperature of the heating roller 51 and the pressure roller 52 when the image is fixed to the sheet P. Then, the CPU 101 sets the temperature of the heating roller 51 to rise to the printing temperature, starts the control of the voltage applied to the heater 53, and then proceeds to the process of S130. For example, as shown in FIG. 5, the CPU 101 sets the temperature of the heating roller 51 to rise to the printing temperature at the time T8, and starts the control of the voltage applied to the heater 53.

By the process of S129, when executing the continuous printing, the CPU 101 controls the heater 53 such that the temperature of the heating roller 51 becomes the printing temperature after the cut sheet P is discharged. Accordingly, since the temperature of the heating roller 51 can be appropriately controlled to perform the printing onto the next sheet P, it is possible to sufficiently fix the image onto the next sheet P.

In S130, when the main motor 108 is being stopped, the CPU 101 resumes the driving of the main motor 108 to rotate the heating roller 51, the pressure roller 52, and the like, and then proceeds to the process of S131. For example, as shown in FIG. 5, the fixing-driving for rotating the pressure roller 52 and the heating roller 51 of the fixing device 5 is resumed at a time T9.

In S131, the CPU 101 determines whether the temperature of each of the heating roller 51 and the pressure roller 52 reaches the sheet feed-enabled temperature via the temperature sensor 54. The sheet feed-enabled temperature is a temperature higher than the standby temperature. Then, when the CPU 101 determines that the temperature of each of the heating roller 51 and the pressure roller 52 reaches the sheet feed-enabled temperature (S131: NO), the CPU 101 executes the process of S131 again.

On the other hand, when the CPU 101 determines that the temperature of each of the heating roller 51 and the pressure roller 52 reaches the sheet feed-enabled temperature (S131: YES), the CPU 101 executes the process of S112 again. Thereafter, for example, at times T10 to T16, the CPU 101 executes processes similar to the processes executed at the times T2 to T8. When the next sheet P is picked up by the pickup roller 31, if the main motor 108 is being driven in S128, the CPU 101 stops the main motor 108 at a time T17 after the elapse of the predetermined time.

Here, when the CPU 101 determines in S117 that the drive duration of the main motor 108 is equal to or larger than the threshold time, the CPU 101 causes the cutter 10 to cut the sheet P in S123 while continuing the driving of the main motor 108. Further, after cutting the sheet P while continuing the driving of the main motor 108, the CPU 101 controls the discharge motor 140 in S125 to rotate the first discharge roller 36 and the second discharge roller 37 and discharge the cut sheet P.

Then, consider the case in which the CPU 101 determines in S127 that there is the image data for the printing on the next sheet P in the print job being executed, and determines in S131 that the temperature of each of the heating roller 51 and the pressure roller 52 reaches the sheet feed-enabled temperature. In this case, the CPU 101 starts feeding of the sheet P next to the sheet P discharged by the first discharge roller 36 and the second discharge roller 37 while continuing the driving of the main motor 108.

The CPU 101 continuously drives the main motor 108 to perform the printing onto the next sheet P, and thus it is possible to restrain the heating roller 51 and the pressure roller 52 from locally rising in temperature. In addition, since the CPU 101 continuously drives the main motor 108, it is possible to reduce a time from the start of the printing onto the sheet P to the end of the printing as compared with a case in which the driving of the main motor 108 is stopped.

In S131, when the temperature of each of the heating roller 51 and the pressure roller 52 reaches the sheet feed-enabled temperature higher than the standby temperature, the CPU 101 conveys the sheet P from the feed tray 21 to the image forming unit 4. As a result, when the sheet P to which the toner is transferred via the photosensitive drum 61 reaches the nip portion N, the temperature of the heating roller 51 can reliably reach the printing temperature at which the image is fixed to the sheet P. For example, as shown in FIG. 5, when the leading end of the sheet P reaches the nip portion N at the time T11, it is possible to reliably set the fixing temperature at the nip portion N to the printing temperature.

### [Modification 1-1]

FIG. 7 is a timing chart showing an example of the relation between the drive timing of each drive unit and the temperature of the fixing device 5 in Modification 1 of the image forming device 1 according to Embodiment 1. As shown in FIG. 7, the CPU 101 may stop the main motor 108 at the time T17 after driving the main motor 108 to rotate in the forward direction at the time T2. That is, the CPU 101 may continuously drive the main motor 108 from the time T2 to the time T17.

Further, the CPU 101 may stop the discharge motor 140 at the time T14 and stop the discharge-driving after resuming the driving of the discharge motor 140 at the time T7. That is, the CPU 101 may continuously drive the discharge motor 140 from the time T7 to the time T14.

Here, an example of the fixing temperature at the nip portion N between the heating roller 51 and the pressure roller 52 will be described with reference to FIG. 7. A graph 72 indicates a change in the fixing temperature at the nip portion N between the heating roller 51 and the pressure roller 52 in Modification 1.

As described above, the CPU 101 continuously drives the main motor 108 from the time T2 to the time T17. Accordingly, in a period from the time T6 to the time T7, that is, in a period in which the discharge motor 140 is stopped, the main motor 108 is driven to rotate the heating roller 51 and the pressure roller 52. Therefore, the fixing temperature at the nip portion N in the period from the time T6 to the time T7 is lower than the fixing temperature at the nip portion N at the time T5.

Therefore, the heating roller 51 and the pressure roller 52 rotate while the first discharge roller 36 and the second discharge roller 37 stop. Thus, it is possible to restrain the heating roller 51 and the pressure roller 52 from locally rising in temperature in the period from the time T6 to the time T7. Thus, it is possible to restrain the decrease in the durability of the fixing device 5.

### [Modification 1-2]

The CPU 101 may execute the process of S115 shown in FIG. 4 between the process of S116 and the process of S117. That is, when the detection signal input from the discharge sensor 112 changes from “OFF” to “ON” (S116: YES), the CPU 101 may start the rotation of the discharge motor 140 in the forward direction and proceed to the process of S117. In this way, the CPU 101 controls the discharge motor 140 based on the time point when the discharge sensor 112 detects the sheet P.

Although in the processes of S121 and S122, the CPU 101 stops the discharge motor 140 to stop the sheet P when the predetermined time has elapsed from the start of the driving of the discharge motor 140, the CPU 101 may stop the discharge motor 140 based on the detection signal input from the post-registration sensor 111 or the discharge sensor 112.

The discharge sensor 112 is disposed downstream of the nip portion N in the conveying direction, and thus the discharge sensor 112 is disposed at a position closer to the first discharge roller 36 and the second discharge roller 37 than the fixing device 5. Further, the sheet P reaches the first discharge roller 36 after the discharge sensor 112 detects the sheet. Therefore, the CPU 101 controls the discharge motor 140 based on the time point when the discharge sensor 112 detects the sheet P, and thus it is possible to start the driving of the discharge motor 140 at an appropriate timing and start the rotation-driving of the first discharge roller 36 and the second discharge roller 37.

### [Modification 1-3]

The CPU 101 may execute the process of S117 shown in FIG. 4 between the process of S114 and the process of S115. That is, after starting the image formation on the sheet P by the image forming unit 4 in S114, the CPU 101 may determine whether the drive duration of the main motor 108 based on the number of sheets in the continuous printing of the print job is equal to or larger than the threshold time. Further, in this case, the CPU 101 proceeds to the process of S115 when the determination in S117 is YES, and executes the process of S118 and then proceeds to the process of S115 when the determination in S117 is NO.

Therefore, the CPU 101 determines whether to execute the process of S118 after the process of S114, and thus the CPU 101 sets the drive duration of the main motor 108 based on the time point when the post-registration sensor 111 detects the sheet P in S113.

The post-registration sensor 111 is disposed between the photosensitive drum 61 and the registration roller 34. Further, the registration roller 34 is a conveying roller closest to the nip portion N in the conveying direction among the plurality of conveying rollers disposed upstream of the photosensitive drum 61. Therefore, the post-registration sensor 111 is disposed at a position as close as possible to the nip portion N on the upstream side of the photosensitive drum 61.

Further, after the post-registration sensor 111 detects the sheet P, the sheet P reaches the nip portion N. Therefore, the CPU 101 sets the drive duration of the main motor 108 based on the time point when the post-registration sensor 111 detects the sheet P, and thus it is possible to stop the driving of the main motor 108 at an appropriate timing to stop the heating roller 51.

### [Modification 1-4]

Instead of the process of S119 shown in FIG. 4, the CPU 101 may execute a process of determining whether the detection signal input from the post-registration sensor 111 changes from “ON” to “OFF”. When the detection signal input from the post-registration sensor 111 does not change from “ON” to “OFF”, the CPU 101 may execute the process again. On the other hand, when the detection signal input from the post-registration sensor 111 changes from “ON” to “OFF”, the CPU 101 may determine that the post-registration sensor 111 detects the passage completion of the sheet P, and proceed to the process of S120.

In this way, the CPU 101 may control the heater 53 such that the temperature of the heating roller 51 becomes the standby temperature in S120 based on the time point when the post-registration sensor 111 detects the passage completion of the sheet P.

The sheet P passes through the nip portion N after a predetermined time has elapsed since the post-registration sensor 111 detects the passage of the sheet P, and thus it is preferable to lower the temperature of the heating roller 51 based on a time point when the post-registration sensor 111 detects the passage of the sheet P. In this case, the CPU 101 controls the heater 53 such that the temperature of the heating roller 51 becomes the standby temperature lower than the printing temperature, and thus it is possible to restrain the heating roller 51 and the pressure roller 52 from locally rising in temperature.

### [Modification 1-5]

In S20 shown in FIG. 3, the CPU 101 may execute a process of determining whether the temperature of each of the heating roller 51 and the pressure roller 52 reaches the printing temperature via the temperature sensor 54. When the CPU 101 determines that the temperature of each of the heating roller 51 and the pressure roller 52 does not reach the printing temperature via the temperature sensor 54, the CPU 101 may execute the above process again. On the other hand, when the CPU 101 determines that the temperature of each of the heating roller 51 and the pressure roller 52 reaches the printing temperature via the temperature sensor 54, the CPU 101 may proceed to the process of S21.

Therefore, when the temperature of the heating roller 51 reaches a predetermined temperature that is a temperature higher than the standby temperature at which the printing on the sheet P waits, the CPU 101 may cause the electromagnetic clutch 107 to be in the transmission state in S112 and convey the sheet P from the feed tray 21. The predetermined temperature is the printing temperature or the sheet feed-enabled temperature.

When the temperature of the heating roller 51 reaches the predetermined temperature that is a temperature higher than the standby temperature, the CPU 101 sets the state in which the drive force is transmitted from the main motor 108 to the pickup roller 31, and conveys the sheet P from the feed tray 21. Therefore, it is possible to sufficiently fix the image onto the sheet P in a state in which the amount of heat required for fixing can be secured with respect to the heating roller 51.

### Embodiment 2

Embodiment 2 of the present disclosure will be described below. For convenience of description, members having the same functions as those described in Embodiment 1 are denoted by the same reference numerals, and description thereof will not be repeated.

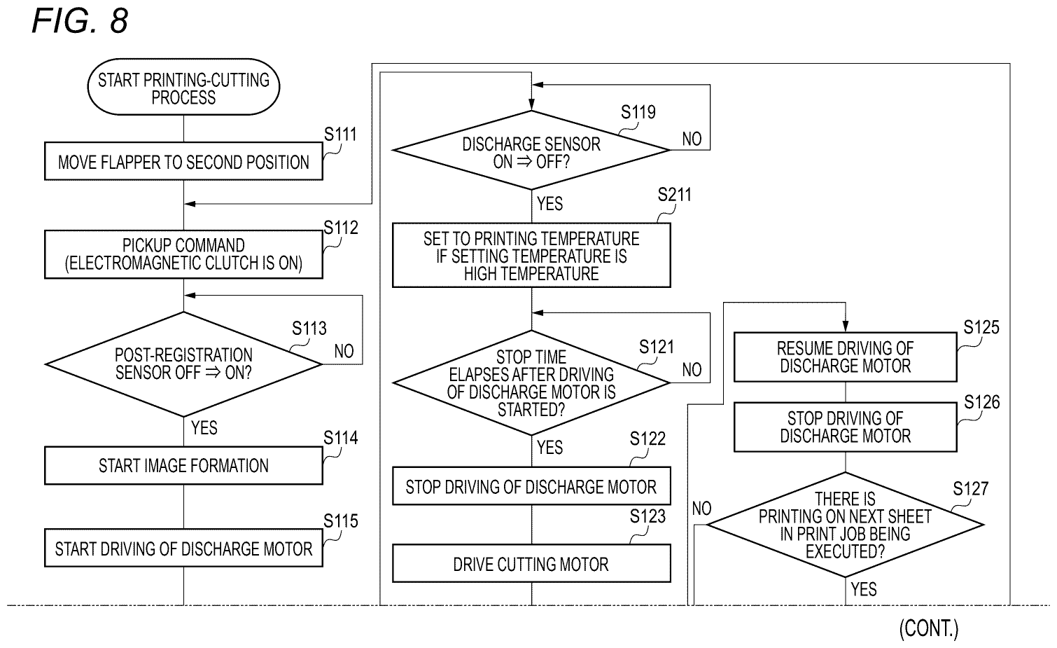

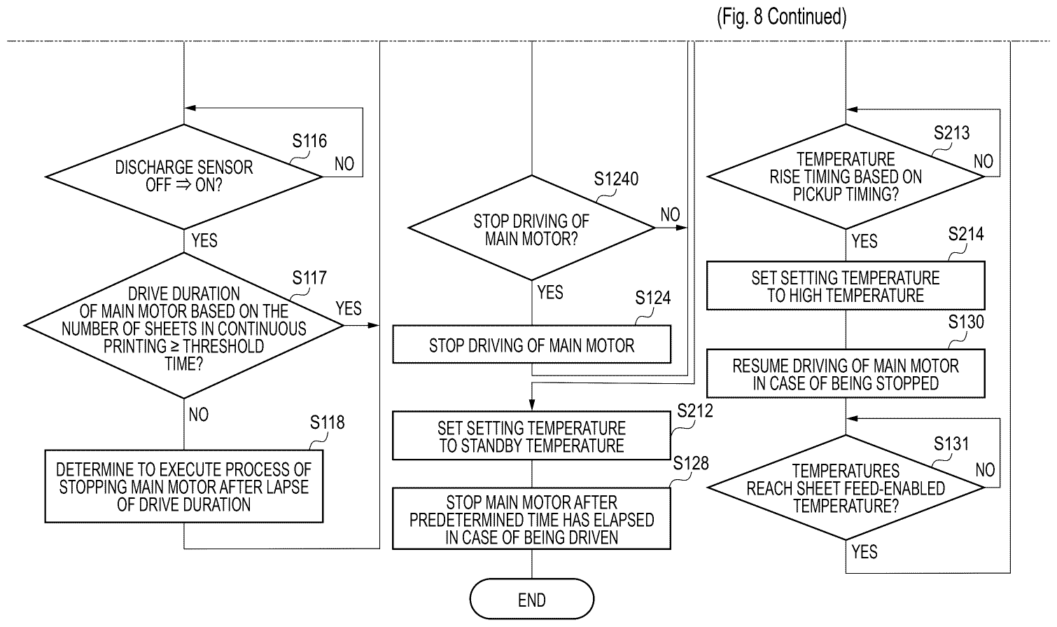

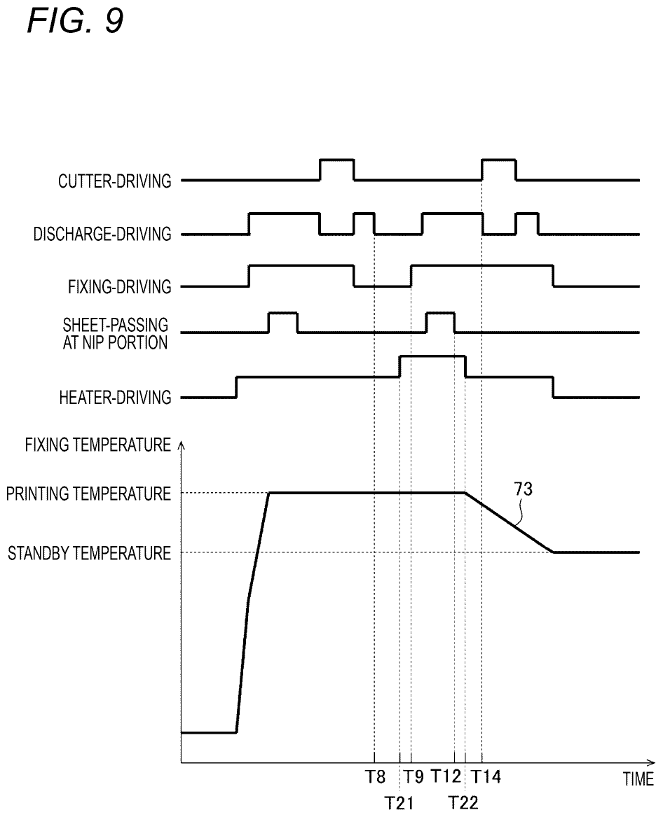

FIG. 8 is a sub flowchart showing an example of the flow of the printing-cutting process in an image forming device according to Embodiment 2. FIG. 9 is a timing chart showing an example of the relation between the drive timing of each drive unit and the temperature of the fixing device 5 in the image forming device according to Embodiment 2. In FIG. 8, the same processes as the processes shown in FIG. 4 are denoted by the same reference numerals as those in FIG. 4. A graph 73 indicates a change in the fixing temperature at the nip portion N between the heating roller 51 and the pressure roller 52 in Embodiment 2.

In Embodiment 2, the CPU 101 may execute a sub process of the printing-cutting process shown in FIG. 8 instead of the sub process of the printing-cutting process shown in FIG. 4 in S21. The printing-cutting process shown in FIG. 8 differs from the printing-cutting process shown in FIG. 4 in that the process of S120 is changed to the process of S211, the processes of S212 and S213 are added, and the process of S129 is changed to the process of S214.

As shown in FIG. 8, after executing the process of S119, if a setting temperature is the high temperature in S211, the CPU 101 reads, from the ROM 102, the printing temperature of the heating roller 51 and the pressure roller 52 when the image is fixed to the sheet P. Then, the CPU 101 sets the temperature of the heating roller 51 to lower to the printing temperature, starts the control of the voltage applied to the heater 53, and then proceeds to the process of S121.

For example, as shown in FIG. 9, the CPU 101 sets the temperature of the heating roller 51 to lower to the printing temperature at a time T22, and starts the control of the voltage applied to the heater 53. The time T22 is a time after the time T12 and before the time T14.

Further, when the CPU 101 determines that there is no image data for the printing on the next sheet P in the print job being executed (S127: NO), the CPU 101 proceeds to the process of S212. In step S212, the CPU 101 reads the standby temperature from the ROM 102. Then, the CPU 101 sets the temperature of the heating roller 51 to lower to the standby temperature, starts the control of the voltage applied to the heater 53, and then proceeds to the process of S128.

Further, when the CPU 101 determines that there is the image data for the printing on the next sheet P in the print job being executed (S127: YES), the CPU 101 proceeds to the process of S213. In S213, the CPU 101 determines whether it is a temperature rise timing based on a pickup timing. The pickup timing is a timing at which the CPU 101 turns on the electromagnetic clutch 107 and sets the electromagnetic clutch 107 to be in the state in which the drive force of the main motor 108 is transmitted to the pickup roller 31 in S112. The temperature rise timing is a timing after a predetermined time has elapsed from the pickup timing, and is an example of a feeding start timing of the sheet P.

When the CPU 101 determines that it is not the temperature rise timing based on the pickup timing (S213: NO), the CPU 101 executes the process of S213 again. On the other hand, when the CPU 101 determines that it is the temperature rise timing based on the pickup timing (S213: YES), the CPU 101 proceeds to the process of S214.

In S214, the CPU 101 reads the high temperature higher than the printing temperature from the ROM 102. Then, the CPU 101 sets the temperature of the heating roller 51 to rise to the high temperature, starts the control of the voltage applied to the heater 53, and then proceeds to the process of S130. For example, as shown in FIG. 9, the CPU 101 sets the temperature of the heating roller 51 to rise to the high temperature at a time T21, and starts the control of the voltage applied to the heater 53. The time T21 is a time after the time T8 and before the time T9.

As described above, when the CPU 101 starts the feeding of the next sheet P while continuing the driving of the main motor 108, the CPU 101 controls the heater 53 such that the temperature of the heating roller 51 becomes the high temperature higher than the printing temperature based on the temperature rise timing. Accordingly, the amount of heat required for fixing can be secured with respect to the heating roller 51 when the printing onto the next sheet P is performed, and thus it is possible to sufficiently fix the image onto the next sheet P.

### Embodiment 3

### [Flow of Print Control by CPU 101]

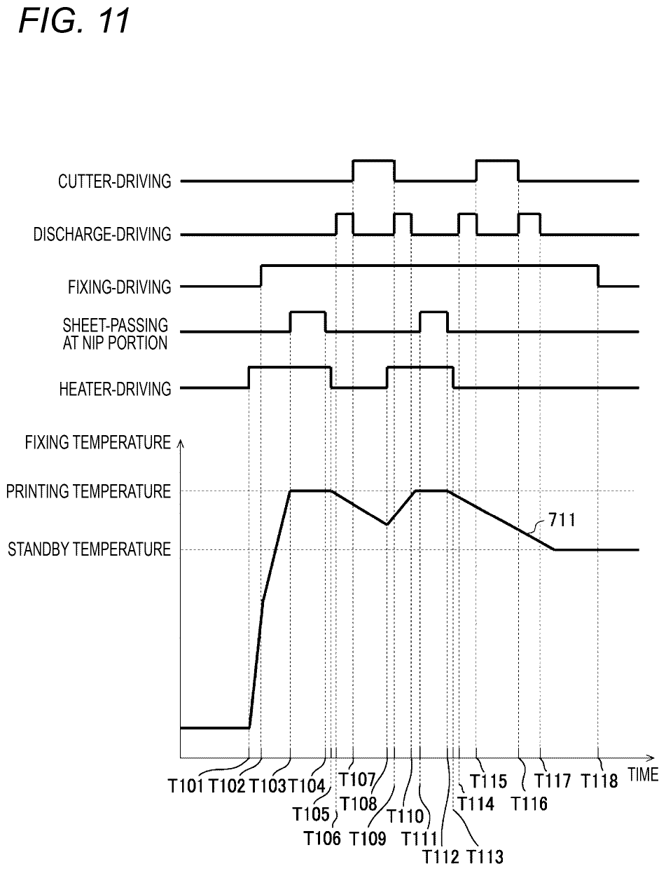

In Embodiment 1 and the present embodiment, the processes in the main flowchart showing the example of the flow of the print control performed by the CPU 101 of the image forming device 1 in FIG. 3 are substantially the same, and a description will now be given of differences thereof. In S13, the CPU 101 starts to drive the heater 53. For example, as shown in FIG. 11, the CPU 101 starts to drive the heater 53 at a time T101. That is, the energization to the heater 53 is started.

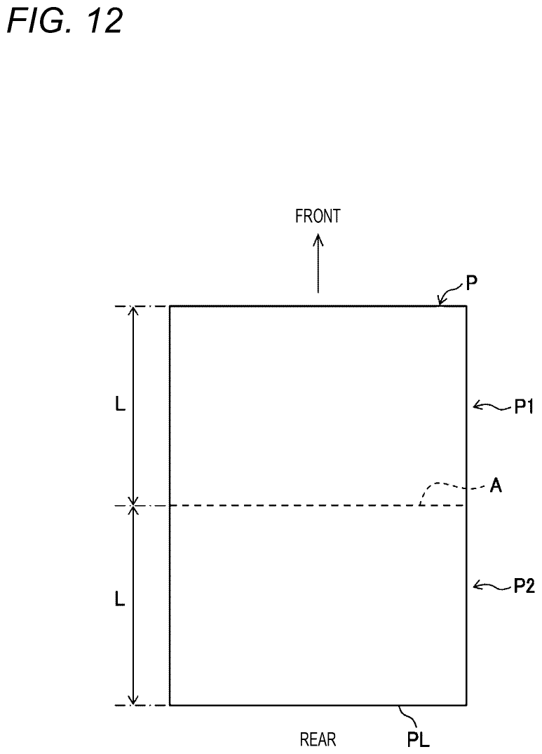

In S17, the CPU 101 determines the cutting position A for cutting the sheet P into two equal portions and stores the cutting position A in the RAM 103. Specifically, as shown in FIG. 12, the CPU 101 determines the cutting position A, at which the sheet P having the A4 size is bisected into the first sheet P1 and the second sheet P2 each having the same length in the conveying direction, as a position for a length L in the conveying direction from the leading end, and stores the position in the RAM 103.

For example, the length L is calculated based on the amount of conveyance of the sheet P detected by the encoder (not shown) until the post-registration sensor 111 detects the leading end of the sheet P and then the post-registration sensor 111 detects the trailing end PL of the sheet P.

Further, in S19, the CPU 101 drives the main motor 108 to rotate in the forward direction and then proceeds to the process of S20. Accordingly, the pressure roller 52, the photosensitive drum 61, the developing roller 64, and the registration roller 34 rotate in the direction in which the sheet P is conveyed in the conveying direction. As a result, for example, as shown in FIG. 11, when the pressure roller 52 or the heating roller 51 of the fixing device 5 is driven to rotate at a time T102, the temperature rise rate of the fixing temperature between the heating roller 51 and the pressure roller 52, that is, at the nip portion N becomes slightly slow. Since the processes other than the above processes are the same as the processes of the main flowchart according to Embodiment 1, the description thereof is omitted.

### [Sub Process of Printing-Cutting Process]

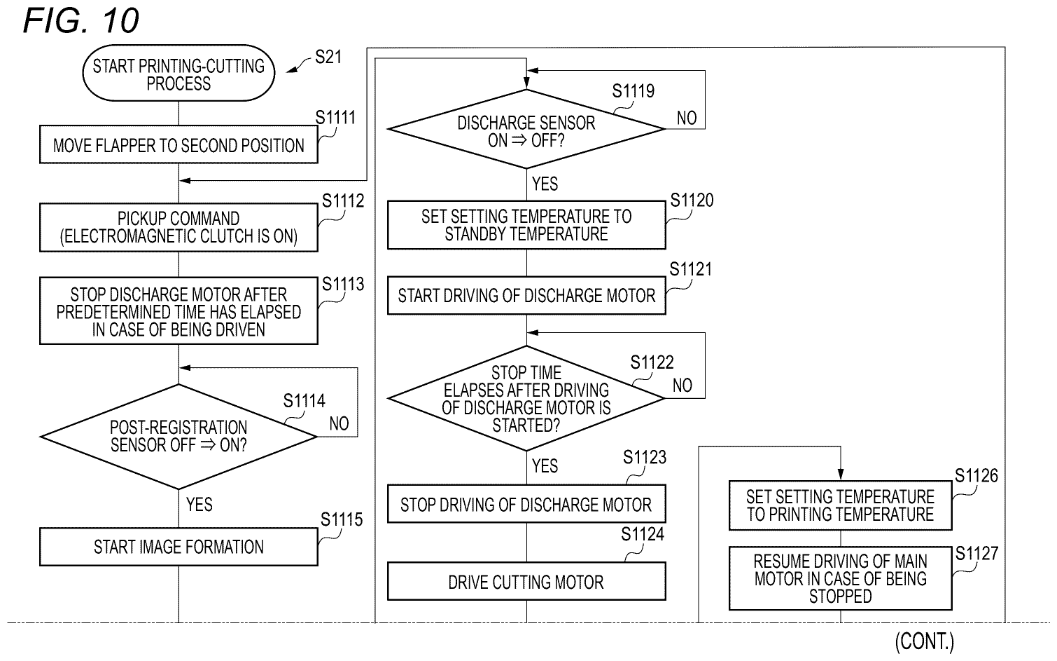

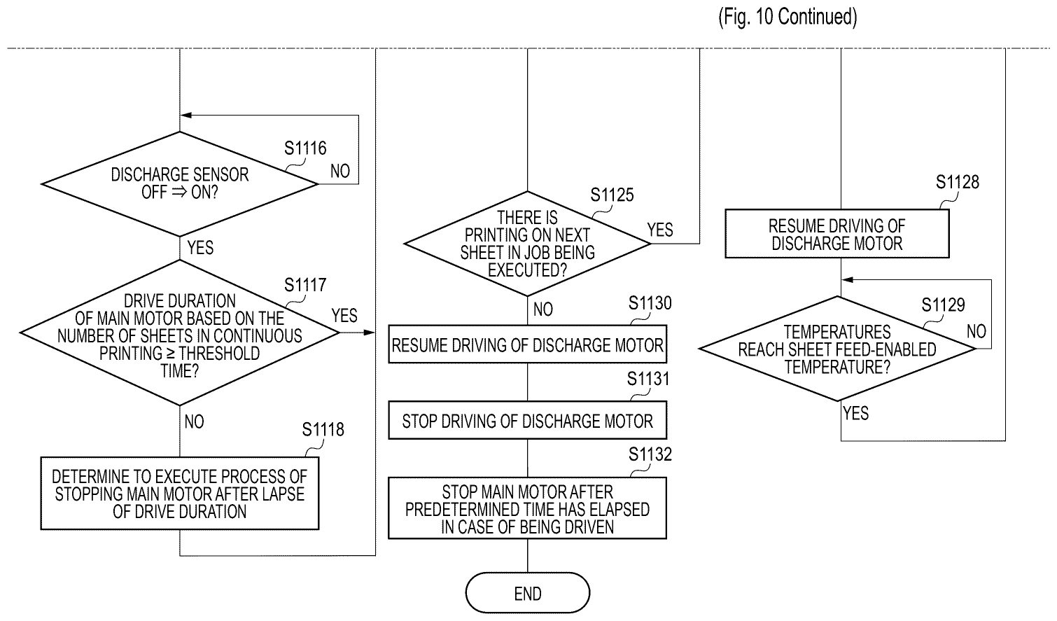

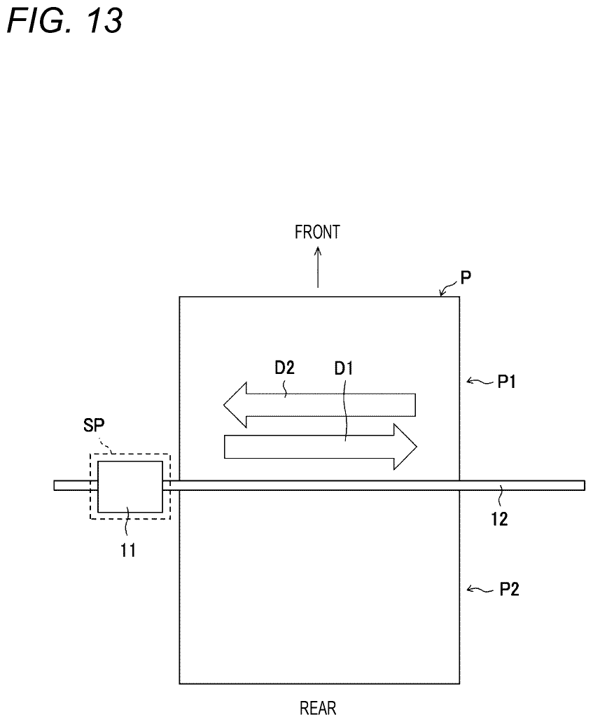

Next, in the present embodiment, an example of the flow of the printing-cutting process executed by the CPU 101 in S21, which is a sub process of the printing-cutting process different from that of Embodiment 1, will be described with reference to FIG. 10. FIG. 10 is a sub flowchart showing the example of the flow of the printing-cutting process. FIG. 11 is a timing chart showing an example of the relation between the drive timing of each drive unit and the temperature of the fixing device 5. FIG. 12 is a diagram for explaining the cutting of the sheet P passing through the nip portion N. FIG. 13 is a diagram for explaining the cutting of the sheet P with the cutter 10. FIG. 11 describes a case in which the drive duration of the main motor 108 is a time larger than the threshold time to be described later.

As shown in FIG. 10, in S1111, the CPU 101 drives the drive motor (not shown) to move the flapper 8 to the second position, and proceeds to the process of S1112. When the flapper 8 moves to the second position, the sheet P is distributed to the conveying path 201. In a case in which the flapper 8 is located at the second position at a start time point of S1111, the CPU 101 maintains the state in which the flapper 8 is located at the second position, and proceeds to the process of S1112.

In S1112, the CPU 101 executes the pickup command for picking up the sheet P in the feed tray 21 by the pickup roller 31. Specifically, the CPU 101 turns on the electromagnetic clutch 107 and sets the electromagnetic clutch 107 to be in the transmission state in which the drive force of the main motor 108 is transmitted to the pickup roller 31. Thereafter, the CPU 101 proceeds to the process of S1113.

In step S1113, when the discharge motor 140 is being driven, the CPU 101 stops the discharge motor 140 after a predetermined time has elapsed and proceeds to the process of S1114. Accordingly, the sheet P can be reliably discharged. When the discharge motor 140 is not being driven, the CPU 101 proceeds to the process of S1114 without executing S1113 after S1112.

In S1114, the CPU 101 determines whether the detection signal input from the post-registration sensor 111 changes from “OFF” to “ON”. Specifically, the CPU 101 determines that the detection signal becomes “ON” by detecting the leading end of the conveyed sheet P by the post-registration sensor 111 and acquiring the detection signal transmitted from the post-registration sensor 111.

Then, when the detection signal input from the post-registration sensor 111 does not change from “OFF” to “ON” (S1114: NO), the CPU 101 executes the process of S1114 again. On the other hand, when the detection signal input from the post-registration sensor 111 changes from “OFF” to “ON” (S1114: YES), the CPU 101 determines that the sheet P has passed, and proceeds to the process of S1115.

In S1115, the CPU 101 starts the image formation on the sheet P by the image forming unit 4. Specifically, the CPU 101 controls the photosensitive drum 61 and the transfer roller TR to form the image based on the image data on the sheet P. That is, the CPU 101 transfers the toner image formed on the photosensitive drum 61 to the sheet P by the transfer roller TR. Then, the image formed on the sheet P is fixed to the sheet P by the fixing device 5.

Subsequently, in S1116, the CPU 101 determines whether the detection signal input from the discharge sensor 112 changes from “OFF” to “ON”. Specifically, the CPU 101 determines that the detection signal becomes “ON” by detecting the leading end of the conveyed sheet P by the discharge sensor 112 and acquiring the detection signal transmitted from the discharge sensor 112. For example, as shown in FIG. 11, the CPU 101 determines that the detection signal input from the discharge sensor 112 changes from “OFF” to “ON” at a time T103.

Then, when the detection signal input from the discharge sensor 112 does not change from “OFF” to “ON” (S1116: NO), the CPU 101 executes the process of S1116 again. On the other hand, when the detection signal input from the discharge sensor 112 changes from “OFF” to “ON” (S1116: YES), the CPU 101 proceeds to the process of S1117.

In S1117, the CPU 101 determines whether the drive duration of the main motor 108 based on the number of sheets in the continuous printing of the print job is equal to or larger than the threshold time. The number of sheets in the continuous printing is counted, for example, based on the number of sheets P having passed through the sensor position of the pre-registration sensor 110 or the like. Further, the number of sheets in the continuous printing may be the number of printed sheets specified in one print job, or may be the total number of printed sheets when the sheets P are continuously printed over a plurality of print jobs. In addition, the number of sheets in the continuous printing may be the number of printed sheets in a case in which an interval between print jobs is within a predetermined time even when printing is interrupted during the print jobs. The drive duration of the main motor 108 based on the number

TABLE 2

| THE NUMBER OF SHEETS IN | DRIVE | |
|---|---|---|
| CONTINUOUS PRINTING | DURATION | |
| 60 OR MORE | 30 | SECONDS |
| 30 TO 59 | 20 | SECONDS |
| 10 TO 29 | 15 | SECONDS |
| LESS THAN 10 | 3 | SECONDS |

When the number of sheets in the continuous printing is 60 or more, the rive duration of the main motor 108 is 30 seconds. When the number of sheets in the continuous printing is 30 to 59, the drive duration of the main motor 108 is 20 seconds. When the number of sheets in the continuous printing is 10 to 29, the drive duration of the main motor 108 is 15 seconds. When the number of sheets in the continuous printing is less than 10, the drive duration of the main motor 108 is 3 seconds.

Accordingly, when the CPU 101 executes the continuous printing in which a plurality of sheets P are continuously printed, the CPU 101 sets the drive duration of the main motor 108 according to the number of the printed sheets P. Further, the drive duration in a case in which each of the heating roller 51 and the pressure roller 52 is provided with a layer made of rubber is preferably larger than the drive duration in a case in which each of the heating roller 51 and the pressure roller 52 is not provided with the layer and a surface thereof is coated.

The threshold time is, for example, 20 seconds. Then, when the CPU 101 determines that the drive duration of the main motor 108 based on the number of sheets in the continuous printing of the print job is equal to or larger than the threshold time (S1117: YES), the CPU 101 proceeds to the process of S1119 to be described later.

On the other hand, when the CPU 101 determines that the drive duration of the main motor 108 based on the number of sheets in the continuous printing of the print job is less than the threshold time (S1117: NO), the CPU 101 proceeds to the process of S1118. In S1118, the CPU 101 determines to execute the process of stopping the main motor 108 after the elapse of the drive duration of the main motor 108, and proceeds to the process of S1119. That is, in S1118, the CPU 101 sets the actual drive duration of the main motor 108 to the time set in S16 or S17.

The CPU 101 determines whether to execute the process of S1118 based on the process of S1117, and thus the CPU 101 sets the drive duration of the main motor 108 based on a time point when the discharge sensor 112 detects the sheet P in S1116.

The discharge sensor 112 is disposed downstream of the nip portion N in the conveying direction. Therefore, the discharge sensor 112 detects the sheet P after the sheet P reaches the nip portion N. Therefore, the CPU 101 sets the drive duration of the main motor 108 based on the time point when the discharge sensor 112 detects the sheet P, and thus it is possible to stop the driving of the main motor 108 at an appropriate timing to stop the heating roller 51.

In S1119, the CPU 101 determines whether the detection signal input from the discharge sensor 112 changes from “ON” to “OFF”. Specifically, when the CPU 101 detects the leading end of the conveyed sheet P by the discharge sensor 112 and then discharges the trailing end of the sheet P, the detection signal transmitted from the discharge sensor 112 cannot be acquired, and thus the CPU 101 determines that the detection signal becomes “OFF”.

Then, when the detection signal input from the discharge sensor 112 does not change from “ON” to “OFF” (S1119: NO), the CPU 101 executes the process of S1119 again. On the other hand, when the detection signal input from the discharge sensor 112 changes from “ON” to “OFF” (S1119: YES), the CPU 101 determines that the discharge sensor 112 detects the passage completion of the sheet P, and proceeds to the process of S1120.

For example, as shown in FIG. 11, when the detection signal input from the discharge sensor 112 changes from “ON” to “OFF” at a time T104, the CPU 101 determines that the discharge sensor 112 detects the passage completion of the sheet P. That is, the CPU 101 determines that the sheet trailing end PL of the sheet P has passed through the nip portion N.

In S1120, the CPU 101 reads the standby temperature of the heating roller 51 and the pressure roller 52 from the ROM 102 at the time of waiting for the conveyance of the sheet P. Then, the CPU 101 sets the temperature of the heating roller 51 to the standby temperature, for example, to be lowered to about 130° C., starts the control of the voltage applied to the heater 53, and then proceeds to the process of S1121. The standby temperature is a temperature lower than the printing temperature. For example, as shown in FIG. 11, the CPU 101 stops the driving of the heater 53 at the time T105. At the timing of a time T105, the passage of the sheet P between the heating roller 51 and the pressure roller 52, that is, through the nip portion N is completed.

By the process of S1120, the CPU 101 controls the heater 53 such that the temperature of the heating roller 51 becomes the standby temperature lower than the printing temperature, based on the time point when the discharge sensor 112 detects the passage completion of the sheet P. After the sheet P has passed through the discharge sensor 112, the heater 53 is controlled such that the temperature of the heating roller 51 becomes the standby temperature lower than the printing temperature. Therefore, it is possible to lower the temperature of the heating roller 51 before the cutting of the sheet P with the cutter 10 is started. Accordingly, it is possible to restrain the heating roller 51 and the pressure roller 52 from locally rising in temperature.

In S1121, the CPU 101 starts the rotation of the discharge motor 140 in the forward direction, rotates the first discharge roller 36 and the second discharge roller 37, and proceeds to the process of S1122. Accordingly, the first discharge roller 36 and the second discharge roller 37 rotate in the direction in which the sheet P is conveyed in the conveying direction. In S1121, the CPU 101 starts the driving of the discharge motor 140 based on the time point when the post-registration sensor 111 detects the sheet P. For example, as shown in FIG. 11, the CPU 101 rotates the discharge motor 140 to start the discharge-driving at a time T106.

Thus, as in the processes of S1114 and S1121, the CPU 101 controls the discharge motor 140 based on the time point when the post-registration sensor 111 detects the sheet P. The post-registration sensor 111 is disposed between the photosensitive drum 61 and the registration roller 34. Further, the registration roller 34 is a conveying roller closest to the first discharge roller 36 and the second discharge roller 37 in the conveying direction among the plurality of conveying rollers disposed upstream of the image forming unit 4. Therefore, the post-registration sensor 111 is disposed at a position as close as possible to the first discharge roller 36 and the second discharge roller 37 on an upstream side of the image forming unit 4.

Further, after the post-registration sensor 111 detects the sheet P, the sheet P reaches the first discharge roller 36. Therefore, the CPU 101 controls the discharge motor 140 based on the time point when the post-registration sensor 111 detects the sheet P, and thus it is possible to start the driving of the discharge motor 140 at an appropriate timing and start the rotation-driving of the first discharge roller 36 and the second discharge roller 37.

In step S1122, the CPU 101 starts to measure the elapsed time from the time point when the rotation of the discharge motor 140 in the forward direction is started. Subsequently, the CPU 101 determines whether the elapsed time from the time point when the rotation of the discharge motor 140 in the forward direction is started reaches the predetermined stop time, that is, whether the predetermined stop time has elapsed. The predetermined stop time is an elapsed time from the time point when the rotation of the discharge motor 140 in the forward direction is started until the cutting position A (see FIG. 12) of the sheet P reaches the disposing position B (see FIG. 1) of the cutter 10. The predetermined stop time is stored in the ROM 102 in advance. For example, the predetermined stop time is an elapsed time from the time T106 to a time T107 shown in FIG. 11.

Then, when the CPU 101 determines that the elapsed time from the time point when the rotation of the discharge motor 140 in the forward direction is started does not reach the predetermined stop time (S1122: NO), the CPU 101 executes the process of S1122 again. On the other hand, when the CPU 101 determines that the elapsed time from the time point when the rotation of the discharge motor 140 in the forward direction is started reaches the predetermined stop time (S1122: YES), the CPU 101 proceeds to the process of S1123.

In S1123, the CPU 101 stops the discharge motor 140 and then proceeds to the process of S1124. For example, as shown in FIG. 11, the CPU 101 stops the discharge motor 140 to stop the discharge-driving at the time T107. Accordingly, since the first discharge roller 36 and the second discharge roller 37 stop in the state of sandwiching the sheet P, the sheet P stops in the state in which the cutting position A is located at the disposing position B of the cutter 10. That is, the CPU 101 stops the first discharge roller 36 and the second discharge roller 37 when the cutting position A on the sheet P reaches the disposing position B of the cutter 10.

By the processes of S1122 and S1123, the CPU 101 stops the discharge motor 140 to stop the sheet P when a predetermined time has elapsed from the start of the driving of the discharge motor 140. Accordingly, the CPU 101 can appropriately control the first discharge roller 36 and the second discharge roller 37 such that the cutting position A on the sheet P reaches the disposing position B of the cutter 10.

In S1124, the CPU 101 drives the cutting motor 106 to reciprocate the blade 75 held by the cutter carriage 11 in the width direction of the sheet P. The CPU 101 starts the driving of the cutting motor 106 and then proceeds to the process of S1125. For example, as shown in FIG. 11, the CPU 101 starts the driving of the cutting motor 106 at the time T107 to start the cutter-driving, and stops the cutting motor 106 at a time T109. Accordingly, the sheet P is cut into two equal portions, that is, the first sheet P1 and the second sheet P2.

In S1125, the CPU 101 determines whether there is image data for the printing on the next sheet P in the print job being executed. The next sheet P refers to the sheet P picked up from the feed tray 21 by the pickup roller 31 next to the sheet P discharged by the first discharge roller 36 and the second discharge roller 37. On the other hand, when the CPU 101 determines that there is the image data for the printing on the next sheet P in the print job being executed (S1125: YES), the CPU 101 proceeds to the process of S1126.

In S1126, the CPU 101 reads, from the ROM 102, the printing temperature of the heating roller 51 and the pressure roller 52 when the image is fixed to the sheet P. Then, the CPU 101 sets the temperature of the heating roller 51 to rise to the printing temperature, starts the control of the voltage applied to the heater 53, and then proceeds to the process of S1127. For example, as shown in FIG. 11, the CPU 101 sets the temperature of the heating roller 51 to rise to the printing temperature at a time T108, and starts the control of the voltage applied to the heater 53.

The CPU 101 performs the process of S1126 before the cutting of the sheet with the cutter is completed. Here, the cutting of the sheet with the cutter will be described with reference to FIG. 13. FIG. 13 shows the cutter 10 located at a standby position SP in a standby state in which the sheet is not cut. When the CPU 101 drives the cutting motor 106 to rotate in the forward direction, the cutter carriage 11 moves in a forward path direction D1 so as to cut the sheet P. Then, the CPU 101 drives the cutting motor 106 to rotate in the reverse direction, which is opposite to the rotation in the forward direction, and moves the cutter carriage 11 in a backward path direction D2 so as to position the cutter carriage 11 at the standby position SP. Thereafter, the CPU 101 stops the cutting motor 106 and completes the cutting of the sheet P.

The CPU 101 may stop the cutting motor 106 after moving the cutter carriage 11 in the forward path direction D1 and cutting the sheet P, move the cutter carriage 11 in the backward path direction D2 to cut the sheet P conveyed thereafter, and then stop the cutting motor 106 and complete the cutting.

Here, an example of the fixing temperature at the nip portion N between the heating roller 51 and the pressure roller 52 will be described with reference to FIG. 11. A graph 711 indicates a change in the fixing temperature at the nip portion N between the heating roller 51 and the pressure roller 52. When the CPU 101 sets the temperature of the heater 53 to the standby temperature and stops the driving of the heater 53 at the time T105, the fixing temperature at the nip portion N starts to decrease from the time T105 as shown in the graph 711.

Then, the CPU 101 is in the state of driving the main motor 108 to rotate the heating roller 51 or the pressure roller 52 from the time T106 to the time T108. Therefore, the fixing temperature at the nip portion N from the time T106 to the time T108 is lower than the fixing temperature at the nip portion N at the time T105.

The CPU 101 drives the main motor 108 before the cutting of the sheet P with the cutter 10 is completed and controls the heater 53, which has been controlled such that the temperature of the heating roller 51 becomes the standby temperature, such that the temperature of the heating roller 51 becomes the printing temperature. Therefore, it is possible to make the temperature of the nip portion N uniform during the cutting of the sheet P, and to facilitate the start of conveyance of the next sheet. Accordingly, it is possible to reduce a decrease in a printing speed in the continuous printing.

Further, according to the configuration in which the CPU 101 executes S1126 after S1124, the heater 53, which has been controlled such that the temperature of the heating roller 51 becomes the standby temperature before the driving of the discharge motor 140, is controlled such that the temperature of the heating roller 51 becomes the printing temperature after the cutting of the sheet P with the cutter 10 is started. Accordingly, it is possible to appropriately control the temperature of the heating roller 51 to perform the printing onto the next sheet P. In addition, it is possible to shorten a time after the cutting of the sheet P is completed until the heater 53 becomes the printing temperature. Accordingly, it is possible to reduce the decrease in the printing speed.

In S1127, when the main motor 108 is being stopped, the CPU 101 resumes the driving of the main motor 108 to rotate the heating roller 51, the pressure roller 52, and the like, and then proceeds to the process of S1128. When the main motor 108 is not being stopped, the CPU 101 proceeds to the process of S1128 without executing S1127 after S1126.

In step S1128, the CPU 101 resumes the driving of the discharge motor 140 to rotate the first discharge roller 36 and the second discharge roller 37 and discharge the cut first sheet P1 and second sheet P2, and then proceeds to the process of S1129. For example, as shown in FIG. 11, the discharge-driving for rotating the first discharge roller 36 and the second discharge roller 37 is resumed at the time T109.

In S1129, the CPU 101 determines whether the temperature of each of the heating roller 51 and the pressure roller 52 reaches the sheet feed-enabled temperature via the temperature sensor 54. The sheet feed-enabled temperature is a temperature higher than the standby temperature. Then, when the CPU 101 determines that the temperature of the heating roller 51 does not reach the sheet feed-enabled temperature (S1129: NO), the CPU 101 executes the process of S1129 again.

On the other hand, when the CPU 101 determines that the temperature of each of the heating roller 51 and the pressure roller 52 reaches the sheet feed-enabled temperature (S1129: YES), the CPU 101 executes the process of S1112 again. In the process of S1113 executed again, the CPU 101 stops the discharge motor 140 driven in the process of S1128 after a predetermined time has elapsed. For example, as shown in FIG. 11, the CPU 101 stops the discharge motor 140 to stop the discharge-driving at a time T110 after the predetermined time has elapsed. Thereafter, for example, at times T111 to T115, the CPU 101 executes processes similar to the processes executed at the times T103 to T107.

Here, when the CPU 101 determines in S1117 that the drive duration of the main motor 108 is equal to or larger than the threshold time, the CPU 101 causes the cutter 10 to cut the sheet P in S1124 while continuing the driving of the main motor 108. Further, after cutting the sheet P while continuing the driving of the main motor 108, the CPU 101 controls the discharge motor 140 in S1128 to rotate the first discharge roller 36 and the second discharge roller 37 and discharge the cut sheet P.

Then, consider the case in which the CPU 101 determines in S1125 that there is the image data for the printing on the next sheet P in the print job being executed, and determines in S1129 that the temperature of each of the heating roller 51 and the pressure roller 52 reaches the sheet feed-enabled temperature. In this case, the CPU 101 starts the feeding of the sheet P next to the sheet P discharged by the first discharge roller 36 and the second discharge roller 37 while continuing the driving of the main motor 108. Accordingly, the CPU 101 continuously drives the main motor 108 to perform the printing onto the next sheet P, and thus it is possible to restrain the heating roller 51 and the pressure roller 52 from locally rising in temperature.

Then, when the CPU 101 determines that there is no image data for the printing on the next sheet P in the print job being executed (S1125: NO), the CPU 101 proceeds to the process of S1130. In step S1130, the CPU 101 resumes the driving of the discharge motor 140 to rotate the first discharge roller 36 and the second discharge roller 37 and discharge the cut first sheet P1 and second sheet P2, and then proceeds to the process of S1131. For example, as shown in FIG. 11, the discharge-driving for rotating the first discharge roller 36 and the second discharge roller 37 is resumed at a time T116.

In S1131, the CPU 101 stops the driving of the discharge motor 140 and then proceeds to the process of S1132. For example, as shown in FIG. 11, the CPU 101 stops the discharge motor 140 to stop the discharge-driving at a time T117.

By the processes of S1124, S1128, S1130 and S1131, after cutting the sheet P with the cutter 10, the CPU 101 controls the discharge motor 140 to rotate the first discharge roller 36 and the second discharge roller 37 and discharge the cut sheet P. Then, after discharging the cut sheet P, the CPU 101 stops the first discharge roller 36 and the second discharge roller 37. Accordingly, when the first discharge roller 36 and the second discharge roller 37 are not required to be driven, the first discharge roller 36 and the second discharge roller 37 are stopped, and thus it is possible to restrain the noise caused by the first discharge roller 36 and the second discharge roller 37.

In S1132, when the main motor 108 is being driven, the CPU 101 stops the main motor 108 after a predetermined time, for example, about 2 seconds to 3 seconds have elapsed. For example, as shown in FIG. 11, the CPU 101 stops the heating roller 51 and the pressure roller 52 of the fixing device 5 by stopping the driving of the main motor 108 at a time T118 so as to stop the fixing-driving. After S1128, the CPU 101 ends the flow shown in FIG. 10 and ends the main flowchart. The timing of “after the elapse of the predetermined time” is also the timing of “after the elapse of the drive duration”.

### [Modification 3-1]

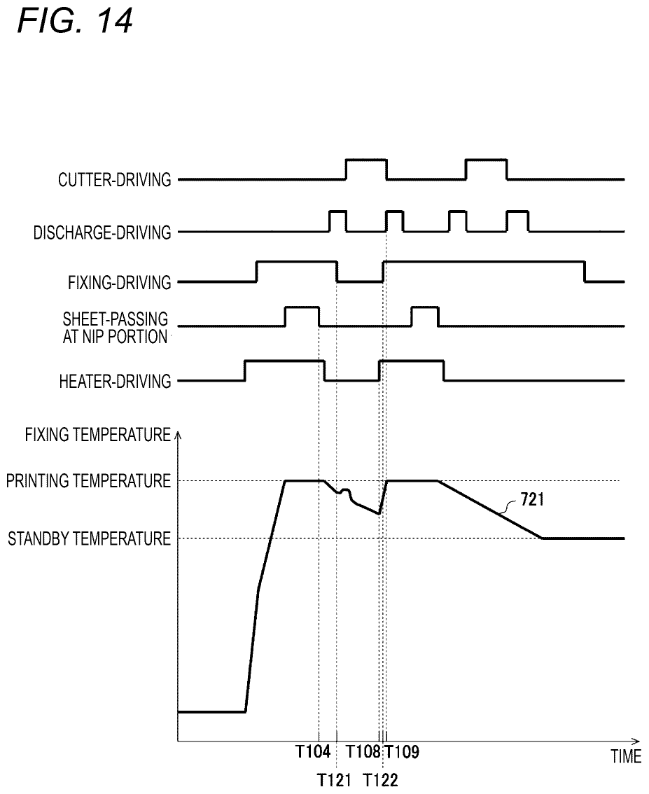

FIG. 14 is a timing chart showing an example of the relation between the drive timing of each drive unit and the temperature of the fixing device 5 in Modification 1 of the image forming device 1 according to Embodiment 3. FIG. 14 describes a case in which the drive duration of the main motor 108 is a time smaller than the threshold time to be described later. A graph 721 indicates a change in the fixing temperature at the nip portion N between the heating roller 51 and the pressure roller 52.

As shown in FIG. 14, after the discharge sensor 112 detects the passage completion of the sheet P at the time T104, the CPU 101 may stop the main motor 108 before raising the temperature of the heating roller 51 to the printing temperature at the time T108. That is, the CPU 101 may stop the main motor 108 from the time T104 to the time T108.

Specifically, when the CPU 101 determines in S1117 of FIG. 10 that the drive duration of the main motor 108 based on the number of sheets in the continuous printing of the print job is less than the threshold time (S1117: NO), the CPU 101 proceeds to the process of S1118. In S1118, the CPU 101 determines to execute the process of stopping the main motor 108 after the elapse of the drive duration of the main motor 108. According to the determination in S1118, the CPU 101 stops the main motor 108 before raising the temperature of the heating roller 51 to the printing temperature in S1126. For example, as shown in FIG. 14, the CPU 101 stops the main motor 108 at a time T121 between the time T104 and the time T108.

In S1127 shown in FIG. 10, the CPU 101 resumes the driving of the main motor 108 that is being stopped to rotate the heating roller 51, the pressure roller 52, and the like, and then proceeds to the process of S1128. For example, as shown in FIG. 14, the CPU 101 drives the main motor 108 at a time T122.

As described above, the CPU 101 stops the driving of the main motor 108 between the time T104 and the time T108. Accordingly, the main motor 108 is stopped in a period from the time T104 to the time T108, that is, in a period after the heater 53 is stopped until the driving of the heater 53 is resumed. For example, when the number of sheets is small, the temperature of the nip portion N can be set lower than the fixing temperature at the time T105 even when the drive duration is shortened.

### [Modification 3-2]

The CPU 101 may execute the process of S1121 shown in FIG. 10 between the process of S1116 and the process of S1117. That is, when the detection signal input from the discharge sensor 112 changes from “OFF” to “ON” (S1116: YES), the CPU 101 may start the rotation of the discharge motor 140 in the forward direction and proceed to the process of S1117. In this way, the CPU 101 controls the discharge motor 140 based on the time point when the discharge sensor 112 detects the sheet P.

Although in the processes of S1121 and S1122, the CPU 101 stops the discharge motor 140 to stop the sheet P when the predetermined time has elapsed from the start of the driving of the discharge motor 140, the CPU 101 may stop the discharge motor 140 based on the detection signal input from the post-registration sensor 111 or the discharge sensor 112.

The discharge sensor 112 is disposed downstream of the nip portion N in the conveying direction, and thus the discharge sensor 112 is disposed at the position closer to the first discharge roller 36 and the second discharge roller 37 than the fixing device 5. Further, the sheet P reaches the first discharge roller 36 after the discharge sensor 112 detects the sheet. Therefore, the CPU 101 controls the discharge motor 140 based on the time point when the discharge sensor 112 detects the sheet P, and thus it is possible to start the driving of the discharge motor 140 at an appropriate timing and start the rotation-driving of the first discharge roller 36 and the second discharge roller 37.

### [Modification 3-3]

The CPU 101 may execute the process of S1117 shown in FIG. 10 between the process of S1114 and the process of S1115. That is, after starting the image formation on the sheet P by the image forming unit 4 in S1114, the CPU 101 may determine whether the drive duration of the main motor 108 based on the number of sheets in the continuous printing of the print job is equal to or larger than the threshold time. Further, in this case, the CPU 101 proceeds to the process of S1115 when the determination in S1117 is YES, and executes the process of S1118 and then proceeds to the process of S1115 when the determination in S1117 is NO.

Therefore, the CPU 101 determines whether to execute the process of S1118 after the process of S1114, and thus the CPU 101 sets the drive duration of the main motor 108 based on the time point when the post-registration sensor 111 detects the sheet P in S1113.

The post-registration sensor 111 is disposed between the photosensitive drum 61 and the registration roller 34. Further, the registration roller 34 is a conveying roller closest to the nip portion N in the conveying direction among the plurality of conveying rollers disposed upstream of the image forming unit 4. Therefore, the post-registration sensor 111 is disposed at a position as close as possible to the nip portion N on the upstream side of the image forming unit 4.

Further, after the post-registration sensor 111 detects the sheet P, the sheet P reaches the nip portion N. Therefore, the CPU 101 sets the drive duration of the main motor 108 based on the time point when the post-registration sensor 111 detects the sheet P, and thus it is possible to stop the driving of the main motor 108 at an appropriate timing to stop the heating roller 51.

### [Modification 3-4]

Instead of the process of S1119 shown in FIG. 10, the CPU 101 may execute the process of determining whether the detection signal input from the post-registration sensor 111 changes from “ON” to “OFF”. When the detection signal input from the post-registration sensor 111 does not change from “ON” to “OFF”, the CPU 101 may execute the process again. On the other hand, when the detection signal input from the post-registration sensor 111 changes from “ON” to “OFF”, the CPU 101 may determine that the post-registration sensor 111 detects the passage completion of the sheet P, and proceed to the process of S1120.

In this way, the CPU 101 may control the heater 53 such that the temperature of the heating roller 51 becomes the standby temperature in S1120 based on the time point when the post-registration sensor 111 detects the passage completion of the sheet P.

By controlling the heater 53 based on a detection result of the post-registration sensor 111, the heater 53 is controlled such that the temperature of the heating roller 51 becomes the standby temperature lower than the printing temperature after the sheet P passes through the post-registration sensor 111. Therefore, it is possible to lower the temperature of the heating roller 51 before the cutting of the sheet P with the cutter 10 is started. Accordingly, it is possible to restrain the nip portion N from locally rising in temperature.

### [Modification 3-5]

In S20 shown in FIG. 3, the CPU 101 may execute the process of determining whether the temperature of each of the heating roller 51 and the pressure roller 52 reaches the printing temperature via the temperature sensor 54. When the CPU 101 determines that the temperature of each of the heating roller 51 and the pressure roller 52 does not reach the printing temperature via the temperature sensor 54, the CPU 101 may execute the above process again. On the other hand, when the CPU 101 determines that the temperature of each of the heating roller 51 and the pressure roller 52 reaches the printing temperature via the temperature sensor 54, the CPU 101 may proceed to the process of S21.

Therefore, when the temperature of the heating roller 51 reaches the predetermined temperature that is a temperature higher than the standby temperature at which the printing on the sheet P waits, the CPU 101 may cause the electromagnetic clutch 107 to be in the transmission state in S112 and convey the sheet P from the feed tray 21. The predetermined temperature is the printing temperature or the sheet feed-enabled temperature.

When the temperature of the heating roller 51 reaches the predetermined temperature that is a temperature higher than the standby temperature, the CPU 101 sets the state in which the drive force is transmitted from the main motor 108 to the pickup roller 31, and conveys the sheet P from the feed tray 21. Therefore, it is possible to sufficiently fix the image onto the sheet P in the state in which the amount of heat required for fixing can be secured with respect to the heating roller 51.

### Embodiment 4

### [Flow of Print Control by CPU 101]

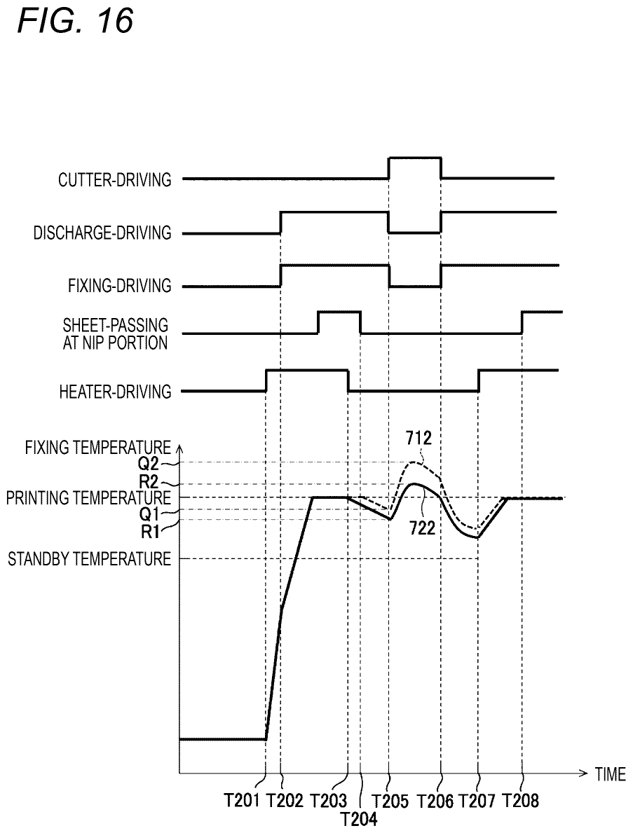

In Embodiment 1 and the present embodiment, the processes in the main flowchart showing the example of the flow of the print control performed by the CPU 101 of the image forming device 1 in FIG. 3 are substantially the same, and a description will now be given of differences thereof. In S13, the CPU 101 starts to drive the heater 53. For example, as shown in FIG. 16, the CPU 101 starts to drive the heater 53 at a time T201. That is, the energization to the heater 53 is started.

In S19, the CPU 101 drives the main motor 108 to rotate in the forward direction and then proceeds to the process of S20. Accordingly, the pressure roller 52, the photosensitive drum 61, the developing roller 64, and the registration roller 34 rotate in the direction in which the sheet P is conveyed in the conveying direction. As a result, for example, as shown in FIG. 16, when the pressure roller 52 or the heating roller 51 of the fixing device 5 is driven to rotate at a time T202, the temperature rise rate of the fixing temperature between the heating roller 51 and the pressure roller 52, that is, at the nip portion N becomes slightly slow. Since the processes other than the above processes are the same as the processes of the main flowchart according to Embodiment 1, the description thereof is omitted.

### [Sub Process of Printing-Cutting Process]

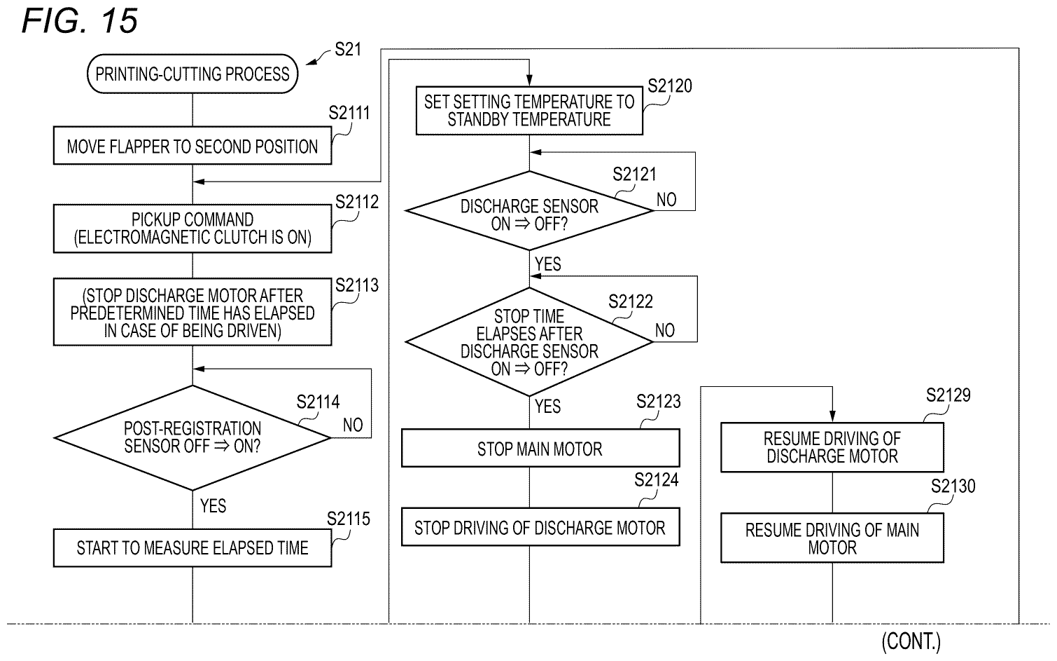

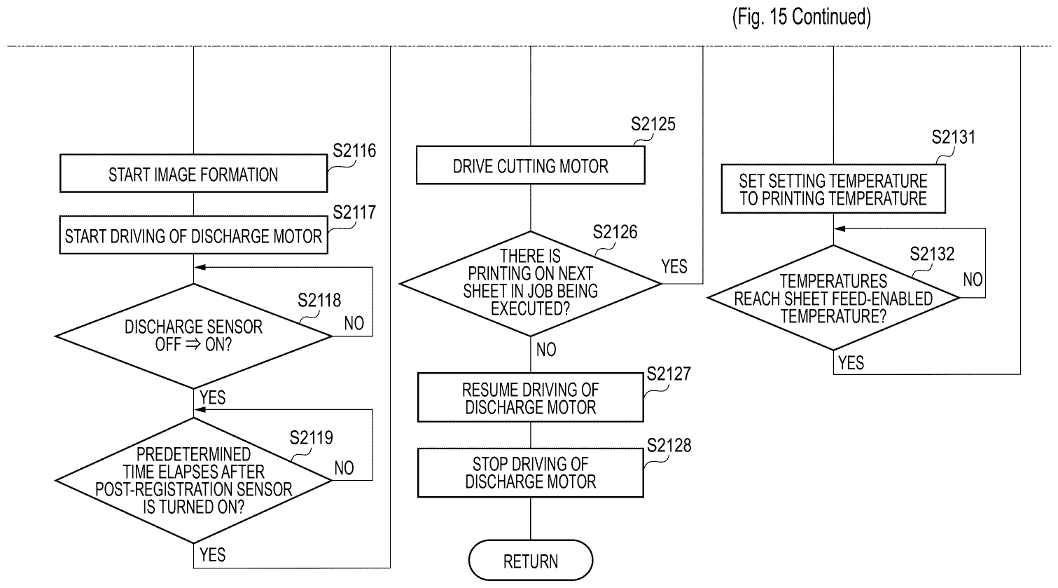

Next, in the present embodiment, an example of the flow of the printing-cutting process executed by the CPU 101, which serves as a sub process of the printing-cutting process different from that of Embodiment 1, will be described with reference to FIG. 15. FIG. 15 is a sub flowchart showing the example of the flow of the printing-cutting process in the present embodiment. As shown in FIG. 15, in S2111, the CPU 101 drives the drive motor (not shown) to move the flapper 8 to the second position, and proceeds to the process of S2112. When the flapper 8 moves to the second position, the sheet P is distributed to the conveying path 201. In a case in which the flapper 8 is located at the second position at a start time point of S2111, the CPU 101 maintains the state in which the flapper 8 is located at the second position, and proceeds to the process of S2112.

In S2112, the CPU 101 executes the pickup command for picking up the sheet P in the feed tray 21 by the pickup roller 31. Specifically, the CPU 101 turns on the electromagnetic clutch 107 and sets the electromagnetic clutch 107 to be in the state in which the drive force of the main motor 108 is transmitted to the pickup roller 31. Thereafter, the CPU 101 proceeds to the process of S2113.

In S2113, when the discharge motor 140 is being driven, the CPU 101 stops the discharge motor 140 after a predetermined time, for example, about 2 seconds to 3 seconds have elapsed, and proceeds to the process of S2114. Accordingly, the sheet P can be reliably discharged. When the discharge motor 140 is not being driven, the CPU 101 proceeds to the process of S2114 without executing S2113 after S2112.

In S2114, the CPU 101 determines whether the detection signal input from the post-registration sensor 111 changes from “OFF” to “ON”. Specifically, the CPU 101 determines that the detection signal becomes “ON” by detecting the leading end of the conveyed sheet P by the post-registration sensor 111 and acquiring the detection signal transmitted from the post-registration sensor 111.

Then, when the detection signal input from the post-registration sensor 111 does not change from “OFF” to “ON” (S2114: NO), the CPU 101 executes the process of S2114 again. On the other hand, when the detection signal input from the post-registration sensor 111 changes from “OFF” to “ON” (S2114: YES), the CPU 101 proceeds to the process of S2115.

In S2115, the CPU 101 starts to measure an elapsed time from a time point when the detection signal input from the post-registration sensor 111 changes from “OFF” to “ON”, and proceeds to the process of S2116. In S2116, the CPU 101 starts the image formation on the sheet P by the image forming unit 4. Specifically, the CPU 101 controls the photosensitive drum 61 and the transfer roller TR to form the image based on the image data on the sheet P. That is, the CPU 101 transfers the toner image formed on the photosensitive drum 61 to the sheet P by the transfer roller TR. Then, the image formed on the sheet P is fixed to the sheet P by the fixing device 5.

Subsequently, in S2117, the CPU 101 starts the rotation of the discharge motor 140 in the forward direction, rotates the first discharge roller 36 and the second discharge roller 37, and proceeds to the process of S2118. Accordingly, for example, as shown in FIG. 16, the discharge-driving for rotating the first discharge roller 36 and the second discharge roller 37 is started at the time T202.

In S2118, the CPU 101 determines whether the detection signal input from the discharge sensor 112 changes from “OFF” to “ON”. Specifically, the CPU 101 determines that the detection signal becomes “ON” by detecting the leading end of the conveyed sheet P by the discharge sensor 112 and acquiring the detection signal transmitted from the discharge sensor 112. Then, when the detection signal input from the discharge sensor 112 does not change from “OFF” to “ON” (S2118: NO), the CPU 101 executes the process of S2118 again. On the other hand, when the detection signal input from the discharge sensor 112 changes from “OFF” to “ON” (S2118: YES), the CPU 101 proceeds to the process of S2119.

In S2119, the CPU 101 determines whether the elapsed time from the time point when the detection signal of the post-registration sensor 111 changes from “OFF” to “ON”, whose measurement is started in S2115, reaches a predetermined time, that is, whether the predetermined time has elapsed. The predetermined time is an example of a “first time”. For example, the predetermined time is an elapsed time from the time T202 to a time T203 shown in FIG. 16.

Then, if the CPU 101 determines that the elapsed time from the time point when the detection signal of the post-registration sensor 111 changes from “OFF” to “ON” does not reach the predetermined time, that is, the predetermined time has not elapsed (S2119: NO), the CPU 101 executes the process of S2119 again. On the other hand, if the CPU 101 determines that the elapsed time from the time point when the detection signal of the post-registration sensor 111 changes from “OFF” to “ON” reaches the predetermined time, that is, the predetermined time has elapsed (S2119: YES), the CPU 101 proceeds to the process of S2120.

In S2120, the CPU 101 reads the standby temperature of the heating roller 51 and the pressure roller 52 from the ROM 102 at the time of waiting for the conveyance of the sheet P. Then, the CPU 101 sets the temperature of the heating roller 51 to the standby temperature, for example, to be lowered to about 130° C., starts the control of the voltage applied to the heater 53, and then proceeds to the process of S2121.

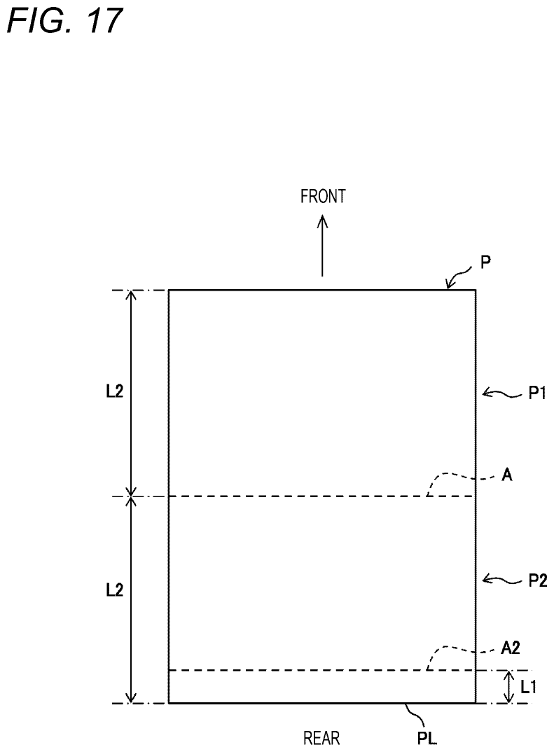

For example, as shown in FIG. 16, the CPU 101 stops the driving of the heater 53 at the time T203. Here, as shown in FIG. 16, the driving of the heater 53 is stopped at the timing of the time T203, but the sheet P does not complete the passage between the heating roller 51 and the pressure roller 52, that is, the passage through the nip portion N at the timing of the time T203. Specifically, for example, the timing of stopping the driving of the heater 53 is a timing at which a position A2 of the sheet P shown in FIG. 17 passes through the nip portion N. The position A2 corresponds to a length L1 from the sheet trailing end PL toward the front side in the conveying direction. The length L1 is preferably equal to or less than a length corresponding to one circumference of the heating roller 51 in order to reliably fix the image to the sheet P.

In S2121, the CPU 101 determines whether the detection signal input from the discharge sensor 112 changes from “ON” to “OFF”. Specifically, when the CPU 101 detects the leading end of the conveyed sheet P by the discharge sensor 112 and then discharges the trailing end of the sheet P, the detection signal transmitted from the discharge sensor 112 cannot be acquired, and thus the CPU 101 determines that the detection signal becomes “OFF”.

Then, when the detection signal input from the discharge sensor 112 does not change from “ON” to “OFF” (S2121: NO), the CPU 101 executes the process of S2121 again. On the other hand, when the detection signal input from the discharge sensor 112 changes from “ON” to “OFF” (S2121: YES), the CPU 101 determines that the discharge sensor 112 detects the passage completion of the sheet P, and proceeds to the process of S2122.

For example, as shown in FIG. 16, when the detection signal input from the discharge sensor 112 changes from “ON” to “OFF” at a time T204, the CPU 101 determines that the discharge sensor 112 detects the passage completion of the sheet P. That is, the CPU 101 determines that the sheet trailing end PL of the sheet P has passed through the nip portion N. Therefore, the CPU 101 can stop the driving of the heater 53 earlier than a time point (the time T204) when the sheet trailing end PL of the sheet P passes through the nip portion N by (the time T204-the time T203).

In S2122, the CPU 101 starts to measure an elapsed time from a time point when the detection signal input from the discharge sensor 112 changes from “ON” to “OFF”. Subsequently, the CPU 101 determines whether the elapsed time from the time point when the detection signal input from the discharge sensor 112 changes from “ON” to “OFF” reaches a predetermined stop time, that is, whether the predetermined stop time has elapsed. The predetermined stop time is an elapsed time from the time point when the detection signal input from the discharge sensor 112 changes from “ON” to “OFF” until the cutting position A (see FIG. 17) of the sheet P reaches the disposing position B (see FIG. 1) of the cutter 10. The predetermined stop time is stored in the ROM 102 in advance. For example, the predetermined stop time is an elapsed time from the time T204 to a time T205 shown in FIG. 16.

Then, when the CPU 101 determines that the elapsed time from the time point when the detection signal input from the discharge sensor 112 changes from “ON” to “OFF” does not reach the predetermined stop time (S2122: NO), the CPU 101 executes the process of S2122 again. On the other hand, when the CPU 101 determines that the elapsed time from the time point when the detection signal input from the discharge sensor 112 changes from “ON” to “OFF” reaches the predetermined stop time (S2122: YES), the CPU 101 proceeds to the process of S2123.

In S2123, the CPU 101 stops the main motor 108 and then proceeds to the process of S2124. For example, as shown in FIG. 16, the driving of the main motor 108 is stopped at the time T205 to stop the heating roller 51 and the pressure roller 52 of the fixing device 5, and the fixing-driving is stopped. Accordingly, when the main motor 108 is not required to be driven, the driving of the main motor 108 is stopped, and thus it is possible to improve the durability of the heating roller 51 and the pressure roller 52 of the fixing device 5 or the like driven by the main motor 108.

In S2124, the CPU 101 stops the discharge motor 140 and then proceeds to the process of S2125. For example, as shown in FIG. 16, the discharge motor 140 is stopped at the time T205 to stop the discharge-driving. Accordingly, since the first discharge roller 36 and the second discharge roller 37 stop in the state of sandwiching the sheet P, the sheet P stops in the state in which the cutting position A (see FIG. 17) is located at the disposing position B (see FIG. 1) of the cutter 10.

In S2125, the CPU 101 drives the cutting motor 106 to reciprocate the blade 75 held by the cutter carriage in the width direction of the sheet P, and then proceeds to the process of S2126. For example, as shown in FIG. 16, the CPU 101 starts the driving of the cutting motor 106 at the time T205 to start the cutter-driving, and stops the cutting motor 106 at a time T206. Accordingly, the sheet P is cut into two equal portions, that is, the first sheet P1 and the second sheet P2.

Here, an example of the fixing temperature at the nip portion N between the heating roller 51 and the pressure roller 52 at the time of cutting the sheet P will be described with reference to FIG. 16. The dashed graph 712 indicates a change in the fixing temperature at the nip portion N when a setting temperature of the heater 53 is set to the standby temperature, for example, to about 130° C. at the time T204 at which the sheet trailing end PL (see FIG. 17) of the sheet P passes through the nip portion N. The solid graph 722 indicates a change in the fixing temperature at the nip portion N when the setting temperature of the heater 53 is set to the standby temperature, for example, to about 130° C. at the time T203 at which the position A2 (see FIG. 17) of the sheet P passes through the nip portion N.

As shown in the dashed graph 712, when the temperature of the heater 53 is set to the standby temperature at the time T204 and the driving of the heater 53 is stopped, the fixing temperature at the nip portion N at the time T205 when the main motor 108 is stopped is a temperature Q1. Then, after the main motor 108 is stopped at the time T205, the fixing temperature at the nip portion N during the cutting of the sheet P with the cutter 10 rises to a temperature Q2.

On the other hand, as shown in the solid graph 722, when the temperature of the heater 53 is set to the standby temperature at the time T203 and the driving of the heater 53 is stopped, the fixing temperature at the nip portion N at the time T205 when the main motor 108 is stopped is a temperature R1 lower than the temperature Q1. Then, after the main motor 108 is stopped at the time T205, the fixing temperature at the nip portion N during the cutting of the sheet P with the cutter 10 rises to a temperature R2 lower than the temperature Q2.

Therefore, at the time T203 when the position A2 (see FIG. 17) on the front side in the conveying direction by the length L1 from the sheet trailing end PL of the sheet P passes through the nip portion N, the setting temperature of the heater 53 is set to the standby temperature. Accordingly, the fixing temperature at the nip portion N during the cutting of the sheet P with the cutter 10 can rise to the temperature R2 lower than the temperature Q2. As a result, it is possible to restrain the nip portion N between the heating roller 51 and the pressure roller 52 from locally rising in temperature, and it is possible to restrain the decrease in the durability of the heating roller 51 and the pressure roller 52 of the fixing device 5 or the like.

Return to FIG. 15, in S2126, the CPU 101 determines whether there is image data for the printing on the next sheet P in the print job being executed. Then, when the CPU 101 determines that there is no image data for the printing on the next sheet P in the print job being executed (S2126: NO), the CPU 101 proceeds to the process of S2127. In step S2127, the CPU 101 resumes the driving of the discharge motor 140 to rotate the first discharge roller 36 and the second discharge roller 37 and discharge the cut first sheet P1 and second sheet P2, and then proceeds to the process of S2128.

In S2128, the CPU 101 stops the driving of the discharge motor 140, ends the flow shown in FIG. 15, and returns to the main flowchart.

On the other hand, when the CPU 101 determines in S2126 that there is the image data for the printing on the next sheet P in the print job being executed (S2126: YES), the CPU 101 proceeds to the process of S2129. In step S2129, the CPU 101 resumes the driving of the discharge motor 140 to rotate the first discharge roller 36 and the second discharge roller 37 and discharge the cut first sheet P1 and second sheet P2, and then proceeds to the process of S2130. In S2130, the CPU 101 resumes the driving of the main motor 108 to rotate the heating roller 51, the pressure roller 52, and the like, and then proceeds to the process of S2131.

For example, as shown in FIG. 16, the CPU 101 stops the cutting motor 106 at the time T206. Further, the CPU 101 resumes the driving of the discharge motor 140 to rotate the first discharge roller 36 and the second discharge roller 37 and discharge the cut first sheet P1 and second sheet P2. The CPU 101 starts the driving of the main motor 108 at the same time as the start of the driving of the discharge motor 140 at the time T206, and resumes the rotation of the heating roller 51, the pressure roller 52, and the like.

In S2131, the CPU 101 reads, from the ROM 102, the printing temperature of the heating roller 51 and the pressure roller 52 when the image is fixed to the sheet P. Then, the CPU 101 sets the temperature of the heating roller 51 to the printing temperature, for example, to rise to about 190° C., starts the control of the voltage applied to the heater 53, and then proceeds to the process of S2132. For example, as shown in FIG. 16, the CPU 101 sets the temperature of the heating roller 51 to rise to the printing temperature at a time T207, and starts the control of the voltage applied to the heater 53.

In S2132, the CPU 101 determines whether the temperature of each of the heating roller 51 and the pressure roller 52 reaches the sheet feed-enabled temperature via the temperature sensor 54. Then, when the CPU 101 determines that the temperature of each of the heating roller 51 and the pressure roller 52 does not reach the sheet feed-enabled temperature (S2132: NO), the CPU 101 executes the process of S2132 again.

On the other hand, when the CPU 101 determines that the temperature of each of the heating roller 51 and the pressure roller 52 reaches the sheet feed-enabled temperature (S2132: YES), the CPU 101 executes the process of S2112 again.

Accordingly, when the temperature of each of the heating roller 51 and the pressure roller 52 reaches the sheet feed-enabled temperature higher than the standby temperature, the CPU 101 conveys the sheet P from the feed tray 21 to the image forming unit 4. As a result, when the sheet P to which the toner is transferred via the photosensitive drum 61 reaches the nip portion N, the temperature of each of the heating roller 51 and the pressure roller 52 can reliably reach the printing temperature at which the image is fixed to the sheet P. For example, as shown in FIG. 16, when the leading end of the sheet P reaches the nip portion N at a time T208, it is possible to reliably set the fixing temperature at the nip portion N to the printing temperature, for example, about 190° C.

### [Modifications]

### [Modification 4-1]

According to the above embodiment, in S2119 shown in FIG. 15, the CPU 101 determines whether the predetermined time has elapsed from the time point when the detection signal of the post-registration sensor 111 changes from “OFF” to “ON”, but the present invention is not limited thereto. For example, the CPU 101 may determine whether a predetermined time has elapsed from a time point when the detection signal input from the discharge sensor 112 changes from “OFF” to “ON”. The predetermined time is an example of a “second time”.

Then, if the CPU 101 determines that the elapsed time from the time point when the detection signal of the discharge sensor 112 changes from “OFF” to “ON” does not reach the predetermined second time, that is, the predetermined second time has not elapsed (S2119: NO), the CPU 101 executes the process of S2119 again. On the other hand, if the CPU 101 determines that the elapsed time from the time point when the detection signal of the discharge sensor 112 changes from “OFF” to “ON” reaches the predetermined second time, that is, the predetermined second time has elapsed (S2119: YES), the CPU 101 may proceed to the process of S2120.

Accordingly, when the sheet P is cut by the cutter 10, the temperature of the heating roller 51 is a temperature lower than the printing temperature at which the image is fixed to the sheet P, and thus it is possible to restrain the nip portion N which the pressure roller 52 and the heating roller 51 are in contact with from locally rising in temperature. As a result, it is possible to restrain the decrease in the durability of the heating roller 51 and the pressure roller 52 of the fixing device 5 or the like.

### [Modification 4-2]

According to the above embodiment, in S2129 to S2130 shown in FIG. 15, the CPU 101 starts the driving of the main motor 108 at the same time as the start of the driving of the discharge motor 140, but the present invention is not limited thereto. For example, the CPU 101 resumes the driving of the discharge motor 140 in S2129 to rotate the first discharge roller 36 and the second discharge roller 37 and discharge the cut first sheet P1 and second sheet P2. Then, the CPU 101 may start the driving of the main motor 108 in S2130 after the driving of the discharge motor 140 is resumed to discharge the cut first sheet P1 and second sheet P2. Accordingly, it is possible to appropriately control the temperature of the heating roller 51 to perform the printing onto the next sheet P.

### [Modifications]

Although the image forming device 1 according to the above embodiments is a monochrome laser printer, the image forming device 1 is not limited thereto and may be a color laser printer.

### [Modifications]

The image forming device 1 according to the above embodiments has been described with respect to the case of cutting the sheet P into two equal portions, but the present invention is not limited thereto, for example, the sheet P may be cut into three equal portions, and the cutting position A on the sheet P may be changed appropriately.

### [Modifications]

Although the image forming device 1 according to the above embodiments receives the print job via the communication I/F 130, the image forming device 1 is not limited thereto and may receive the print job via, for example, a USB interface.

### [Supplementary Notes]

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image forming device comprising:
an image forming unit configured to form an image on a sheet;
a fixing unit configured to fix the image on the sheet, the fixing unit including:
a heating rotation body;
a heater configured to heat the heating rotation body; and
a pressure rotation body configured to form a nip portion between the heating rotation body and the pressure rotation body;
a discharge roller disposed downstream of the fixing unit in a conveying direction of the sheet, and configured to discharge the sheet;
a main motor configured to transmit a drive force to at least one of the heating rotation body or the pressure rotation body;
a cutter disposed downstream of the fixing unit in the conveying direction, and configured to cut the sheet; and
a controller,
wherein the controller is configured to:
control the heater such that a temperature of the fixing unit becomes a first temperature for fixing the image on the sheet;
control the main motor to rotate the heating rotation body or the pressure rotation body to convey the sheet;
stop the discharge roller in a case where a cutting position on the sheet reaches a disposing position of the cutter, and then control the cutter to cut the sheet with the cutter; and
at a time point when cutting of the sheet with the cutter starts:
set a target value of the temperature of the fixing unit to a second temperature lower than the first temperature to control the heater; or
control the main motor to drive the main motor to rotate the heating rotation body or the pressure rotation body.

2. The image forming device according to claim 1, further comprising:
a discharge motor configured to transmit a drive force to the discharge roller,
wherein the controller is configured to:
control the discharge motor to rotate the discharge roller to convey the sheet having passed through the nip portion, and stop the discharge roller in a case where the cutting position on the sheet reaches the disposing position of the cutter, and
after stopping the discharge roller, start the cutting of the sheet with the cutter in a state where the main motor is driven to rotate the heating rotation body or the pressure rotation body.

3. The image forming device according to claim 2,
wherein the image forming unit includes a photosensitive drum,
the image forming device further comprises:
a registration roller that is a conveying roller closest to the photosensitive drum among a plurality of conveying rollers configured to convey the sheet, and that is disposed upstream of the photosensitive drum in the conveying direction; and
a first sheet sensor disposed between the photosensitive drum and the registration roller in the conveying direction, and configured to detect passage of the sheet, and
the controller is configured to control the discharge motor based on a time point when the first sheet sensor detects the sheet.

4. The image forming device according to claim 2,
wherein in a case where a predetermined time elapses from the start of driving of the discharge motor, the controller stops the discharge motor to stop the sheet.

5. The image forming device according to claim 2,
wherein the controller is configured to:
in a case where continuous printing in which a plurality of sheets are continuously printed is executed, set a drive duration of the main motor according to the number of the printed sheets; and
in a case where the drive duration is equal to or larger than a threshold time, after cutting the sheet with the cutter, in a state where the main motor is continuously driven, control the discharge motor to rotate the discharge roller, discharge the cut sheet, and start to feed the sheet next to the sheet discharged by the discharge roller.

6. The image forming device according to claim 5,
wherein the image forming unit includes a photosensitive drum,
the image forming device further comprises:
a registration roller that is a conveying roller closest to the photosensitive drum among a plurality of conveying rollers configured to convey the sheet, and that is disposed upstream of the photosensitive drum in the conveying direction; and
a first sheet sensor disposed between the photosensitive drum and the registration roller in the conveying direction, and configured to detect passage of the sheet, and
the controller is configured to set the drive duration based on a time point when the first sheet sensor detects the sheet.

7. The image forming device according to claim 6,
wherein the controller is configured to control the heater such that the temperature of the fixing unit becomes the second temperature lower than the first temperature, based on a time point when the first sheet sensor detects passage completion of the sheet.

8. The image forming device according to claim 2, further comprising:
a feed tray on which the sheet is placed;
a pickup roller configured to convey the sheet from the feed tray to the image forming unit in a case where the drive force is transmitted from the main motor; and
a clutch configured to switching between a transmission state in which the drive force is transmitted from the main motor to the pickup roller, and a non-transmission state in which the drive force is not transmitted from the main motor to the pickup roller,
wherein in a case where the temperature of the fixing unit reaches a predetermined temperature that is a temperature higher than a standby temperature at which printing onto the sheet waits, the controller is configured to cause the clutch to be in the transmission state to convey the sheet from the feed tray.

9. The image forming device according to claim 1, further comprising:
a discharge motor configured to transmit a drive force to the discharge roller,
wherein the controller is configured to:
control the discharge motor to convey the sheet having passed through the nip portion by rotating the discharge roller, and stop the discharge roller in a case where the cutting position on the sheet reaches the disposing position of the cutter,
control the heater such that the target value of the temperature of the fixing unit becomes the second temperature lower than the first temperature, after the heating rotation body or the pressure rotation body starts to rotate and before the discharge roller is stopped, and
in a case where continuous printing in which a plurality of sheets are continuously printed is executed, control the heater such that the temperature of the fixing unit becomes the first temperature, before the cutting of the sheet with the cutter is completed.

10. The image forming device according to claim 9,
wherein the image forming unit includes a photosensitive drum,
the image forming device further comprises:
a registration roller that is a conveying roller closest to the photosensitive drum among a plurality of conveying rollers configured to convey the sheet, and that is disposed upstream of the photosensitive drum in the conveying direction; and
a first sheet sensor disposed between the photosensitive drum and the registration roller in the conveying direction, and configured to detect passage of the sheet, and
the controller is configured to control the discharge motor based on a time point when the first sheet sensor detects the sheet.

11. The image forming device according to claim 9,
wherein the fixing unit includes a second sheet sensor disposed downstream of the nip portion in the conveying direction, the second sheet sensor being configured to detect passage of the sheet, and
the controller is configured to control the heater such that the target value of the temperature of the fixing unit becomes the second temperature, based on a time point when the second sheet sensor detects passage completion of the sheet.

12. The image forming device according to claim 9,
wherein the image forming unit includes a photosensitive drum,
the image forming device further comprises:
a registration roller that is a conveying roller closest to the photosensitive drum among a plurality of conveying rollers configured to convey the sheet, and that is disposed upstream of the photosensitive drum in the conveying direction; and
a first sheet sensor disposed between the photosensitive drum and the registration roller in the conveying direction, and configured to detect passage of the sheet, and
the controller is configured to control the heater such that the target value of the temperature of the fixing unit becomes the second temperature, based on a time point when the first sheet sensor detects passage completion of the sheet.

13. The image forming device according to claim 9,
wherein in a case where the continuous printing is executed, the controller controls the heater such that the temperature of the fixing unit becomes the first temperature, after the cutting of the sheet with the cutter is started.

14. The image forming device according to claim 9, further comprising:
a feed tray on which the sheet is placed;
a pickup roller configured to convey the sheet from the feed tray to the image forming unit when the drive force is transmitted from the main motor; and
a clutch configured to switch between a transmission state in which the drive force is transmitted from the main motor to the pickup roller, and a non-transmission state in which the drive force is not transmitted from the main motor to the pickup roller,
wherein in a case where the temperature of the fixing unit reaches a predetermined temperature that is a temperature higher than a standby temperature at which printing onto the sheet waits, the controller is configured to cause the clutch to be in the transmission state to convey the sheet from the feed tray.

15. The image forming device according to claim 1,
wherein the controller is configured to:
set the target value of the temperature of the fixing unit to the second temperature lower than the first temperature to control the heater, before a sheet trailing end of the sheet passes through the nip portion, and
cause the discharge roller to rotate to convey the sheet having passed through the nip portion, stop the discharge roller in a case where the cutting position on the sheet reaches the disposing position of the cutter, and then cut the sheet with the cutter.

16. The image forming device according to claim 15,
wherein the controller is configured to stop driving of the main motor, after the sheet trailing end passes through the nip portion.

17. The image forming device according to claim 15,
wherein the image forming unit includes a photosensitive drum,
the image forming device further comprises:
a registration roller that is a conveying roller closest to the photosensitive drum among a plurality of conveying rollers configured to convey the sheet, and that is disposed upstream of the image forming unit in the conveying direction; and
a first sheet sensor disposed between the photosensitive drum and the registration roller in the conveying direction, and configured to detect passage of the sheet, and
in a case where a first time elapses from a time point at which the first sheet sensor detects the sheet, the controller is configured to set the target value of the temperature of the fixing unit to the second temperature to control the heater.

18. The image forming device according to claim 15,
wherein the fixing unit includes a second sheet sensor disposed downstream of the nip portion in the conveying direction, the second sheet sensor being configured to detect passage of the sheet, and
in a case where a second time elapses from a time point at which the second sheet sensor detects the sheet, the controller is configured to set the target value of the temperature of the fixing unit to the second temperature to control the heater.

19. The image forming device according to claim 15, further comprising:
a feed tray on which the sheet is placed;
a pickup roller configured to convey the sheet from the feed tray to the image forming unit when the drive force of the main motor is transmitted; and
a clutch configured to switch between a transmission state in which the drive force is transmitted from the main motor to the pickup roller, and a non-transmission state in which the drive force is not transmitted from the main motor to the pickup roller,
wherein the controller is configured to:
in a case where the temperature of the fixing unit reaches a sheet feed temperature higher than the second temperature, cause the clutch to switch to the transmission state to transmit the drive force from the main motor to the pickup roller, and
convey the sheet from the feed tray to the image forming unit.

20. The image forming device according to claim 15,
wherein the controller is configured to sets the target value of the temperature of the fixing unit to the second temperature to control the heater, at a timing after the sheet passes through the nip portion at a position on a downstream side in the conveying direction by a distance corresponding to one circumference of the heating rotation body from the sheet trailing end and before the sheet trailing end passes through the nip portion.
